(19) United States
(12) Patent Application Publication
(10) Pub. No.: US 2023/0226519 A1
(43) Pub. Date: Jul. 20, 2023

(54) Metal Chelating Functional Graphene Materials

(71) Applicant: Carnegie Mellon University, Pittsburgh, PA (US)

(72) Inventors: Stefanie A. Sydlik, Pittsburgh, PA (US); Anne M. Arnold, Pittsburgh, PA (US); Edward P. Zovinka, Duncansville, PA (US); Michelle M. Karpinsky, Miami, FL (US)

(21) Appl. No.: 18/007,853

(22) PCT Filed: Jun. 4, 2021
(86) PCT No.: PCT/US2021/035901

§ 371 Date: Dec. 2, 2022

Related U.S. Application Data
(60) Provisional application No. 63/035,054, filed on Jun. 5, 2020.

(51) Int. Cl. B01J 20/22; C02F 1/28; C02F 1/68; C01B 32/194; C01B 32/198; B01J 20/20; B01J 20/28; B01J 20/32

(52) U.S. Cl. CPC B01J 20/22; C02F 1/288; C02F 1/683; C01B 32/194; C01B 32/198; B01J 20/205; B01J 20/28009; B01J 20/28042; B01J 20/28033; B01J 20/3204; B01J 20/3219; B01J 20/3265; C02F 1/283; C02F 1/285; C02F 2101/10

(57) ABSTRACT

Described herein is a functional graphene composition comprising a graphene scaffold and one or more metal chelating functional groups covalently bonded to the graphene scaffold and a porous substrate that includes the functional graphene composition. Also provided is a method of removing dissolved metals from an aqueous liquid, such as, acid mine drainage.

### CROSS REFERENCE TO RELATED APPLICATIONS

This application is the United States national phase of International Application No. PCT/US2021/035901 filed Jun. 4, 2021, and claims priority to U.S. Provisional Application No. 63/035,054 filed Jun. 5, 2020, the disclosures of which are hereby incorporated by reference in their entirety.

### BACKGROUND OF THE INVENTION

Acid mine drainage (AMD) is a pervasive source of metal pollution that impacts freshwater ecosystems and has a direct impact on human health. Most AMD originates from mines that have exposed rocks containing sulfide minerals. When sulfide minerals are exposed to air and water they are oxidized, resulting in the formation of sulfuric acid. High concentrations of metal ions, such as iron, manganese, and aluminum are dissolved by the acidic water and flow out into surface water

To remove these metals, the drainage water must be neutralized by raising the pH to precipitate the metal particles. Conventional active and passive treatment methods work well for removing iron during AMD remediation, which is typically the most prevalent metallic impurity. However, conventional passive remediation may fail to remove other metallic impurities, such as, aluminum, which have severe ecological implications. Removal of metal ions, such as, aluminum ions, traditionally uses small molecules that chelate metals tightly for sequestration. Chelation strategies suffer constraints because once introduced into surface water, small molecules are difficult to reclaim and often persist in the environment as pollutants.

Superior methods of sequestration of dissolved metals from AMD or other aqueous liquids is desirable, especially those that allow for reclamation of those metals.

### SUMMARY OF THE INVENTION

In one aspect or embodiment, a functional graphene composition is provided, comprising: a graphene scaffold; and one or more metal chelating functional groups covalently bonded to the graphene scaffold, wherein the one or more metal chelating functional groups comprise a N-alkoxyamide or hydroxamic acid moiety.

In another aspect or embodiment, a porous structure is provided comprising: a porous substrate; and a functional graphene composition on the porous substrate, comprising a metal-chelating functional group covalently bonded to a graphene scaffold, wherein the metal-chelating functional group comprises a carboxyl moiety, a hydroxamic acid moiety, a N-alkoxylamide moiety, a catechol moiety, or a combination thereof.

In another aspect or embodiment, a method of removing dissolved metal from an aqueous liquid is provided. The method comprises: adding to the aqueous liquid a compound comprising a functionalized graphene comprising a metal-chelating functional group covalently bonded to a graphene, wherein the metal-chelating functional group comprises a carboxyl moiety, a hydroxamic acid moiety, a N-alkoxylamide moiety, a catechol moiety, or a combination thereof, thereby, chelating the dissolved metal.

Non-limiting aspects of the present invention will now be described in the following numbered clauses:

Clause 1. A functional graphene composition, comprising: a graphene scaffold; and one or more metal chelating functional groups covalently bonded to the graphene scaffold, wherein the one or more metal chelating functional groups comprise a N-alkoxyamide or hydroxamic acid moiety.

Clause 2. The compound of clause 1, wherein the graphene scaffold comprises graphene oxide.

Clause 3. The compound of clause 1, wherein the graphene scaffold comprises Claisen graphene oxide.

Clause 4. The compound of any one of clauses 1-3, wherein the N-alkoxyamide moiety comprises the structure:

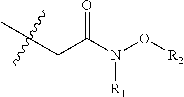

where R₁ comprises or is a hydrogen or C₁₋₆ alkyl; and where R₂ comprises or is —(CH₂)ₙ—CH₃, where n ranges from 0 to 5, e.g., R₁ is hydrogen.

Clause 5. The compound of any one of clauses 1-3, wherein the hydroxamic acid moiety comprises the structure:

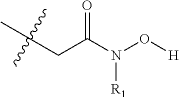

where R₁ comprises or is hydrogen or C₁₋₆ alkyl, e.g., R₁ is hydrogen.

Clause 6. The compound of any of one of clauses 1-5, wherein the graphene scaffold further comprises magnetic nanoparticles linked thereto.

Clause 7. The compound of clause 6, wherein the magnetic nanoparticles comprise iron, cobalt, nickel, copper, zinc, strontium, barium, or a combination thereof.

Clause 8. A porous structure comprising: a porous substrate; and a functional graphene composition on the porous substrate, comprising a metal-chelating functional group covalently bonded to a graphene scaffold, wherein the metal-chelating functional group comprises a carboxyl moiety, a hydroxamic acid moiety, a N-alkoxylamide moiety, a catechol moiety, or a combination thereof.

Clause 9. The porous structure of clause 8, wherein the metal-chelating functional group comprises a N-alkoxyamide moiety having the structure:

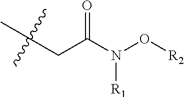

where R₁ comprises or is hydrogen or C₁₋₆ alkyl; and where R₂ comprises or is —(CH₂)ₙ—CH₃, where n ranges from 0 to 5.

Clause 10. The porous structure of claim 8, wherein the metal-chelating functional group comprises a hydroxamic acid moiety having the structure:

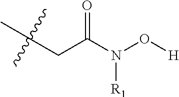

where R₁ comprises or is hydrogen or C₁₋₆ alkyl, e.g., R₁ is hydrogen.

Clause 11. The porous structure of clause 8, wherein the metal-chelating functional group comprises a 1,2-dihydroxybenzene moiety.

Clause 12. The porous structure of clause 11, wherein the metal-chelating functional group comprises an N-[2-(3,4-dihydroxyphenyl)ethyl]amide moiety.

Clause 13. The porous structure of any one of clauses 8-12, wherein the porous substrate comprises a clay, a rock, a polysaccharide, a polymer, a ceramic, a graphene, or a combination of any of the preceding.

Clause 14. The porous structure of any one of clauses 8-13, wherein the porous substrate is a three-dimensional graphene matrix.

Clause 15. The porous structure of clause 14, wherein the three-dimensional graphene matrix is formed from the functional graphene composition.

Clause 16. The porous structure of any one of clauses 8-13, wherein the porous substrate comprises a porous sheet.

Clause 17. The porous structure of any one of clauses 8-13, wherein the porous substrate comprises a mesh.

Clause 18. The porous structure of any one of clauses 8-17, wherein the functional graphene composition is covalently bonded to the porous substrate.

Clause 19. The porous structure of any one of clauses 8-17, wherein the functional graphene composition is non-covalently complexed with the porous substrate.

Clause 20. A method of removing dissolved metal from an aqueous liquid, the method comprising: adding to the aqueous liquid a compound comprising a functionalized graphene comprising a metal-chelating functional group covalently bonded to a graphene, wherein the metal-chelating functional group comprises a carboxyl moiety, a hydroxamic acid moiety, a N-alkoxylamide moiety, a catechol moiety, or a combination thereof, thereby chelating the dissolved metal.

Clause 21. The method of clause 20, wherein the metal-chelating functional group comprises a N-alkoxyamide moiety comprising the structure:

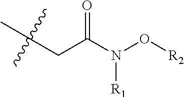

where R₁ comprises or is hydrogen or C₁₋₆ alkyl; and where R₂ comprises or is —(CH₂)ₙ—CH₃, where n ranges from 0 to 5, e.g., R₁ is hydrogen.

Clause 22. The method of clause 20, wherein the metal-chelating functional group comprises a hydroxamic acid moiety having the structure:

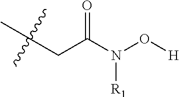

where R₁ comprises or is hydrogen or C₁₋₆ alkyl, e.g., R₁ is hydrogen.

Clause 23. The method of clause 20, wherein the metal-chelating functional group comprises a 1,2-dihydroxybenzene moiety.

Clause 24. The method of clause 23, wherein the metal-chelating functional group comprises an N-[2-(3,4-dihydroxyphenyl)ethyl] amide moiety.

Clause 25. The method of any one of clauses 20-24, wherein the functionalized graphene is on a porous substrate, or forms a porous structure

Clause 26. The method of clause 25, wherein the functionalized graphene is on a porous substrate, and the porous substrate comprises a clay, a rock, a polysaccharide, a polymer, a ceramic, a graphene, or a combination of any of the preceding.

Clause 27. The method of any one of clauses 20-26, wherein the porous substrate comprises a sheet.

Clause 28. The method of any one of clauses 20-26, wherein the porous substrate comprises a mesh.

Clause 29. The method of any one of clauses 25-28, wherein the functional graphene composition is covalently bonded to a porous substrate.

Clause 30. The method of any one of clauses 25-28, wherein the functional graphene composition is non-covalently complexed with a porous substrate.

Clause 31. The method of any one of clauses 20-30, wherein the aqueous liquid is drinking water or wastewater.

Clause 32. The method of any one of clauses 20-31, wherein the aqueous liquid is acidified or neutral.

Clause 33. The method of any one of clauses 20-32, wherein the aqueous liquid is acid mine drainage.

Clause 34. The method of any one of clauses 20-33, wherein the dissolved metal comprises aluminum (Al), lead (Pb), mercury (Hg), iron (Fe), manganese (Mn), cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y), or any combination thereof.

Clause 35. The method of clause 34, wherein the dissolved metal comprises aluminum.

Clause 36. The method of any one of clauses 20-35, further comprising after adding the compound to the aqueous liquid to chelate the dissolved metal, optionally, washing the composition comprising the chelated metal under conditions in which the metal is retained on the composition, and eluting the chelated metal from the composition.

### BRIEF DESCRIPTION OF THE DRAWINGS

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limit of the invention.

FIG. 1 depicts the material design of aluminum-chelating functional graphenic materials (FGMs) for acid mine drainage remediation. Aluminum-chelating functional groups (carboxylic acids, hydroxamic acids, and catechols) are represented on the left and the corresponding FGM scaffold containing the functional group is contained within the same row. Edge functionalized FGMs and basal plane functionalized FGMs are also depicted.

FIG. 2 depicts schematically a porous substrate affixed with the FGMs of the present invention.

FIG. 3 is a reaction scheme depicting the synthesis of graphene oxide (GO) from graphite using a modified Hummers' method. A section of a graphenic flake is represented for simplicity, where bold lines represent sheet edges.

FIG. 4 is a synthetic scheme to generate Claisen graphene (CG), hydroxamic acid functional graphenic materials (FGMs), and catechol FGMs. CG was synthesized from GO using a modified, Johnson-Claisen reaction. Hydroxamic acid FGMs were prepared from either GO or CG using a carbodiimide-assisted procedure with hydroxylamine, generating either hydroxamic acid graphene oxide (HA-GO) or hydroxamic acid Claisen graphene (HA-CG). Catechol FGMs were synthesized from either GO or CG via thionyl chloride amidation of FGMs with 3,4-dihydroxybenzylamine (DHBA). The resulting catechol FGMs were catechol graphene oxide (CGO) and catechol Claisen graphene (CCG). The graphenic flakes are represented as pyrene structures for simplicity and bold lines signify sheet edges.

FIGS. 5A-5B are Fourier transform infrared (FTIR) spectra of FGMs. FIG. 5A is FTIR spectra of edge functionalized FGMs containing carboxylic acids (GO), HA-GO, and CGO shown from top to bottom, respectively. FIG. 5B is FTIR spectra of basal plane functionalized FGMs containing carboxylic acids (CG), HA-CG, and CCG shown from top to bottom, respectively. All spectra were normalized and offset for clarity.

FIGS. 6A-6D are X-ray photoelectron spectroscopy (XPS) spectra of edge- and basal plane-modified FGM powders. Edge functionalized FGMs containing carboxylic acids (GO), HA-GO, and CGO are shown from top to bottom, respectively, in FIGS. 6A and 6C. Basal plane functionalized FGMs containing carboxylic acids (CG), HA-CG, and CCG are shown from top to bottom, respectively, in FIGS. 6B and 6D. FIGS. 5A and 5B are XPS survey spectra of FGMs with the oxygen (O1s), nitrogen (N1s), carbon (C1s), chlorine (C12p), bromine (Br3p), and sulfur (S2p) emission peaks labelled. FIGS. 6C and 6D are elemental composition of FGMs using the emission peaks labelled in FIGS. 6A and 6B, respectively. Bars represent the average of n=3 measurements obtained at different spots on the material. The error bars are the standard deviation. Note that chlorine, bromine, and sulfur are denoted with asterisks because they are impurities resulting from the synthesis pathway of CGO and CCG.

FIGS. 7A-7E represent deconvolutions of high-resolution XPS carbon (Cis) spectra of edge- and basal plane-modified FGM powders. Edge functionalized FGMs containing carboxylic acids (GO) and basal plane functionalized FGMs containing carboxylic acids (CG) are shown in FIG. 7A. FIG. 7A is a representation of the carbon-containing functional groups on the FGMs, where carboxylic acids, carbonyl groups, alcohol, epoxides, and sp³ and sp² carbons are highlighted. FIGS. 7B and 7C are deconvoluted XPS Cls spectra of GO and CG, respectively with carboxylic acids at 289.0 electronvolts (eV), carbonyls at 287.4 eV, alcohol and epoxides at 286.5 eV, and sp³ and sp² carbons at 284.8 eV. FIGS. 7D and 7E are graphs depicting the quantification of the atomic percent of carbon groups in GO and CG, determined by taking the area under the curve of each emission peak in FIGS. 7B and 7C, respectively. Bars represent the average of n=3 measurements obtained at different spots on the material. The error bars are the standard deviation. Note that edge and basal plane carboxylic acids are indistinguishable in the high-resolution spectra.

FIGS. 8A-8B are FTIR spectra of hydroxamic acid FGMs and the reagents used and byproducts produced during synthesis. FIG. 8A is a FTIR spectra of HA-GO, HA-CG, benzohydroxamic acid (BHA), 1-Ethyl-3-(3-dimethylaminopropyl)carbodiimide (EDC), N-hydroxysuccinimide (NHS), hydroxylamine (NH₂OH), and urea. The carbodiimide (CDI), imide, and hydroxamic acid (HA) stretches indicative of EDC, NHS, and the hydroxamic acid functional group on BHA, respectively. Further, a peak indicative of NH₂OH is indicated by *. FIG. 8B is an inset of FTIR spectra from FIG. 8A, where the CDI, *, and imide stretches are labelled, indicating that EDC, NH₂OH, and NHS are not present in the hydroxamic acid FGMs. Note that all spectra were normalized and offset for clarity. Urea, which is a byproduct of the HA FGM synthesis is also shown, but, all stretches overlap with functional groups on the FGMs. Similarly, the HA stretch also overlaps with functional groups on the FGMs.

FIG. 9 are proton NMR (¹H-NMR) spectra of D₂O mixed with FGMs. The FGMs were filtered to separate the FGM and D₂O filtrate. The ¹H -NMR spectra were acquired using the D₂O filtrates.

FIG. 10 is a graph depicting the graphite furnace calibration curve.

FIGS. 11A-11D depict the aluminum chelating capacity of FGMs. FIG. 11A is a representation of the spatial distribution of aluminum chelating groups on the graphenic backbone for edge and basal plane functionalization. FIG. 11B is a graph depicting the mass of aluminum removed from a stock solution treated with FGMs, measured via a graphite furnace (top). The mass of aluminum adsorbed onto the surface of FGMs after treatment, as determined from the survey scans acquired using XPS (bottom). The bars are the average of n=3 samples and the error bars represent the standard deviation. FIG. 11C is an energy-dispersive X-ray (EDX) image of FGM samples, where measured adsorbed aluminum is displayed. FIG. 11D is high resolution XPS spectra of aluminum adsorbed onto the surface of FGMs. The peaks at 74.5 eV are representative of adsorbed aluminum particles whereas the peaks at 70.5 eV represent chelated aluminum ions. The relative percentages of the adsorbed aluminum particles and chelated aluminum ions were determined from the total area under the Al2p curve.

FIGS. 12A-12D depict XPS of edge- and basal plane-modified FGMs with chelated and adsorbed aluminum. FIGS. 12A and 12B are XPS survey spectra of FGMs with the Ols, N1s, C1s, Cl2p, Br3p, S2p, and Al2p emission peaks labelled. FIGS. 12C and 12D are graphs depicting the composition of FGMs using the emission peaks labelled in FIGS. 12A and 12B, respectively. Bars represent the average of n=3 measurements obtained at different spots on the material. The error bars are the standard deviation. Note that chlorine, bromine, and sulfur are denoted with asterisks because they are impurities resulting from the synthesis pathway of CGO and CCG.

FIGS. 13A-13E depict XPS results of edge- and basal plane-modified FGMs after aluminum removal to regenerate the materials. FIGS. 13A and 13B are XPS survey spectra of FGMs with the O1s, N1s, C1s, Cl2p, Br3p, S2p, and Al2p emission peaks labelled. FIGS. 13C and 13D are elemental composition of FGMs using the emission peaks labelled in FIGS. 13A and 13B, respectively. Bars represent the average of n=3 measurements obtained at different spots on the material. The error bars are the standard deviation. Note that chlorine, bromine, and sulfur are denoted with asterisks because they are impurities resulting from the synthesis pathway of CGO and CCG. FIG. 13E are high resolution XPS spectra of aluminum adsorbed onto the surface of FGMs. The peaks at 74.5 eV are representative of adsorbed aluminum particles whereas the peaks at 70.5 eV represent chelated aluminum ions. The relative percentages of the adsorbed aluminum particles and chelated aluminum ions were determined from the total area under the Al2p curve.

FIGS. 14A-14D depict XPS results of edge- and basal plane-modified functional graphenic materials (FGMs) after 1 week in acid mine drainage-like conditions (pH 4). FIGS. 14A and 14B are XPS survey spectra of FGMs with the O1, N1s, C1s, Cl2p, Br3p, S2p, and Al2p emission peaks labelled. FIGS. 14C and 14D are elemental composition of FGMs using the emission peaks labelled in FIGS. 14A and 14B, respectively. Bars represent the average of n=3 measurements obtained at different spots on the material. The error bars are the standard deviation. Note that chlorine, bromine, and sulfur are denoted with asterisks because they are impurities resulting from the synthesis pathway of CGO and CCG.

FIGS. 15A-15B are deconvolution spectra of high-resolution XPS carbon (Cis) spectra of edge- and basal plane-modified FGMs after 1 week in acid mine drainage-like conditions (pH 4). FIGS. 15A and 15B show deconvoluted XPS Cls spectra of GO and CG, respectively. Carboxylic acids are at 289.0 electronvolts (eV), carbonyls are at 287.4 eV, alcohols and epoxides are at 286.5 eV, and sp³ and sp² carbons are at 284.8 eV. Note that quantification of the atomic percent of carbon groups in GO and CG were determined by taking the area under the curve of each emission peak. Note that edge and basal plane carboxylic acids are indistinguishable in the high-resolution spectra.

FIGS. 16A-16C relate to the deconvolution of high-resolution XPS nitrogen (Nis) spectra of edge- and basal plane-modified FGMs after 1 week in acid mine drainage-like conditions (pH 4). FIG. 16A is a representation of the possible nitrogen-containing functional groups present in the FGMs resulting from the catechol. Free amines, which can arise from unbound catechol and/or catechols bound to the graphenic backbones via an ester bond, are highlighted. Amides, where catechols are bound to the graphenic backbones via an amide linkage, are highlighted. FIGS. 16B and 16C are deconvoluted XPS N1s spectra of HA-GO and HA-CG, respectively. The free amine is at 400.1 eV and the amide is at 398.8 eV.

FIGS. 17A-17D relate to the deconvolution of XPS nitrogen (N1s) spectra of edge- and basal plane-modified FGM powders. FIGS. 17A and 17B are deconvoluted XPS N1s spectra of HA-GO and HA-CG. The free amine is at 400.1 eV and the amide is at 398.8 eV. FIGS. 17C and 17D are graphs depicting the quantification of the atomic percent of nitrogen groups in HA-GO and HA-CG, determined by taking the area under the curve of each emission peak in FIGS. 17A and 17B, respectively. Bars represent the average of n=3 measurements obtained at different spots on the material. The error bars are the standard deviation.

FIGS. 18A and 18B demonstrate the microbial compatibility of FGMs with E. coli using the LIVE/DEAD® BacLight™ assay. FIGS. 18A and 18B are graphs depicting the percent of live bacteria after exposure to 0.01, 0.1, and 1.0 mg mL⁻¹ of FGMs for 16 hours at 37° C. The percent of live bacteria is normalized to the no treatment control. Bars represent the average of n=3 replicates and the error is the standard deviation.

FIGS. 19A-19B depict fluorescence spectroscopy of the LIVE/DEAD® BacLight™ standards consisting of 0-100% live E. coli cells. FIG. 19A is an emission spectra of the E. coli standards with the green (530 nm) and red (630 nm) fluorescence labelled. FIG. 19B is a calibration curve of the E. coli standards using the green-to-red fluorescence ratio labelled in FIG. 12A.

FIGS. 20A-20D depict absorption spectroscopy results of FGM dispersions sans E. coli cells stained with the LIVE/DEAD® BacLight™ kit. FIGS. 20A and 20B are absorption spectra of graphene oxide (GO) (FIG. 20A) and Claisen graphene (CG) (FIG. 20B) dispersions ranging from 0-1 mg mL⁻¹. FIGS. 20C and 20D are plots of the absorbance of the GO (FIG. 20C) and CG (FIG. 20D) dispersions at 470 nm, which is the excitation wavelength utilized for the LIVE/DEAD® BacLight™ assay.

FIGS. 21A-21D depict fluorescence spectroscopy of FGM dispersions sans E. coli cells stained with the LIVE/DEAD® BacLight™ kit. FIGS. 21A and 21B are fluorescence emission spectra of graphene oxide (GO) (FIG. 21A) and Claisen graphene (CG) (FIG. 21B) dispersions ranging from 0-1 mg mL⁻¹ with an excitation wavelength of 470 nm. The green (530 nm) and red (630 nm) fluorescence is labeled on the emission spectra. FIGS. 21C and 21D are plots of the green-to-red fluorescence ratio of the GO (FIG. 21C) and CG (FIG. 21D) dispersions using the intensity of the green and red fluorescence labelled in FIGS. 21A and 21B, respectively.

### DESCRIPTION OF THE INVENTION

Other than in the operating examples, or where otherwise indicated, the use of numerical values in the various ranges specified in this application are stated as approximations as though the minimum and maximum values within the stated ranges are both preceded by the word “about”. In this manner, slight variations above and below the stated ranges can be used to achieve substantially the same results as values within the ranges. Also, unless indicated otherwise, the disclosure of ranges is intended as a continuous range including every value between the minimum and maximum values. Further, as used herein, all numbers expressing dimensions, physical characteristics, processing parameters, quantities of ingredients, reaction conditions, and the like, used in the specification and claims are to be understood as being modified in all instances by the term “about”. Moreover, unless otherwise specified, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like.

As used herein “a” and “an” refer to one or more. The term “comprising” is open-ended and may be synonymous with “including”, “containing”, or “characterized by”. The term “consisting essentially of” limits the scope of a claim to the specified materials or steps and those that do not materially affect the basic and novel characteristic(s) of the claimed invention. The terms “a” and “an” are intended to refer to one or more.

As used herein, spatial or directional terms, such as “left”, “right”, “inner”, “outer”, “above”, “below”, “over”, “under”, and the like, relate to the invention as it is shown in the drawing figures are provided solely for ease of description and illustration, and do not imply directionality, unless specifically required for operation of the described aspect of the invention. It is to be understood that the invention can assume various alternative orientations and, accordingly, such terms are not to be considered as limiting.

As used herein, “chelation” is the formation of multiple coordination bonds between an organic molecule and a metal ion, leading to sequestration of the metal.

As used herein, “polymers” can include without limitation, homopolymers, heteropolymers, co-polymers, block polymers, block co-polymers, and can be both natural and synthetic. Homopolymers contain one type of building block, or monomer, whereas co-polymers contain more than one type of monomer. An “oligomer” can be a polymer that comprises a small number of monomers, such as, for example, from 3 to 100 monomer residues. As such, the term “polymer” can include oligomers.

A “group” or “functional group” is a portion of a larger molecule comprising or consisting of a grouping of atoms and/or bonds that confer a chemical or physical quality to a molecule. A “residue” is the portion of a compound or monomer that remains in a larger molecule, such as, a polymer chain, after incorporation of that compound or monomer into the larger molecule. A “moiety” is a portion of a molecule, and can comprise one or more functional groups.

“Alkyl” refers to straight, branched chain, or cyclic hydrocarbon groups including from 1 to about 20 carbon atoms, for example, and without limitation, C₁₋₃, C₁₋₆, C₁₋₁₀ groups, for example, and without limitation, straight, branched chain alkyl groups such as, methyl, ethyl, propyl, butyl, pentyl, hexyl, heptyl, octyl, nonyl, decyl, undecyl, dodecyl, and the like. “Substituted alkyl” refers to alkyl substituted at 1 or more, e.g., 1, 2, 3, 4, 5, or even 6 positions, which substituents are attached at any available atom to produce a stable compound, with substitution as described herein. “Optionally substituted alkyl” refers to alkyl or substituted alkyl. “Halogen,” “halide,” and “halo” refers to F, Cl, Br, and/or I. “Alkylene” and “substituted alkylene” refer to divalent alkyl and divalent substituted alkyl, respectively, including, without limitation, ethylene (—CH₂—CH₂—). “Optionally substituted alkylene” refers to alkylene or substituted alkylene.

“Hydroxamic acid” refers to an organic compound having the structure: R—C(O)—N(OH)—R′ where R and R′ can be any suitable atom, molecule, or polymer chain unless specifically indicated otherwise, and R and R′ may be the same or different from one another. The suitable atom may include a hydrogen atom or any other suitable atom. The C(O) is a carbonyl group having an oxygen double bonded to the carbon atom.

The present invention relates to compounds having metal chelating properties. The compounds of the present invention are functional graphene materials having one or more chelating functional groups covalently bonded to a graphene scaffold that provide metal chelating properties and can be used in a variety of applications, such as, for the removal of dissolved metals from aqueous liquids, for acid mine drainage remediation, or for aqueous liquid purification. These compounds are referred to herein as functional graphenic materials (FGMs). Accordingly, the FGM can be added to or otherwise contacted with an aqueous liquid to remove dissolved metals, such as, a passive treatment system for acid mine drainage remediation. The FGM may remain in the passive treatment system, thereby, removing dissolved metals from the aqueous liquid flowing thereover.

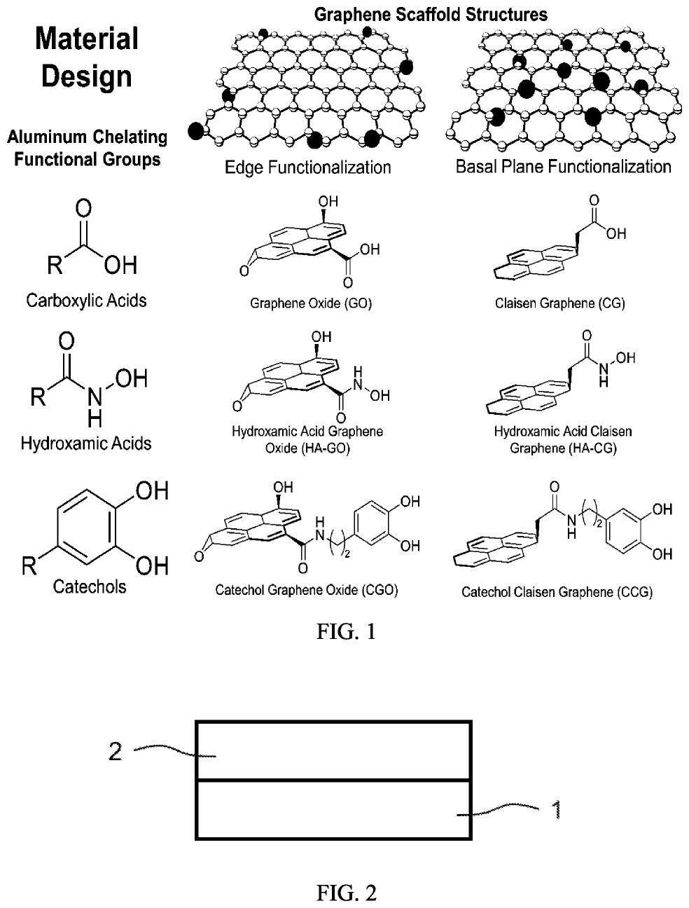

The FGMs of the present invention are graphene scaffolds functionalized by covalently attaching one or more metal chelating functional groups to the graphene scaffold, where the metal chelating functional groups have a carboxylic acid, a N-alkoxyamide, a hydroxamic acid, or a catechol moiety (FIG. 1). The FGM may be a graphene scaffolds functionalized by covalently attaching one or more metal chelating functional groups comprising a hydroxamic acid moiety. The graphene scaffold can be derived from a graphenic material. The graphenic material may be sheets, tubes, or fullerenes. For example, the graphene scaffold may be graphene oxide (GO), which are atomically thin, micro-sized sheets of carbon atoms that are bound together and oxidized. The GO can be formed from the oxidization of graphite, such as, through a modified Hummers' method (Dideikin et al.; Hummers Jr., W. S. et al. Preparation of Graphitic Oxide, Journal of the American Chemical Society, 1958, 80(6): 1339; Arnold, A. M. et al. Functional Graphenic Materials That Seal Condenser Tube Leaks in Situ. ACS Appl. Mater. Interfaces 2019, 11(23): 20881-20887), which introduces oxygen-containing groups onto the edges or on the basal plane of the graphene oxide scaffold. The edges of the graphene oxide scaffold may include carboxylic acid functional groups and the basal plane of the graphene oxide scaffold may include tertiary alcohols and epoxides (Dideikin et al.). The carboxylic acid, tertiary alcohols, or epoxide functional groups present on the GO may be used to covalently bond one or more chelating functional groups to the GO scaffold.

The graphene scaffold may be Claisen Graphene (CG), which is derived from GO. The tertiary alcohols present on the basal plane of the GO scaffold can be transformed into carboxylic acids via a Johnson-Claisen rearrangement (Sydlik, S. A. et al. Advanced Functional Materials 2013, 23(15), 1873-1882; Arnold et al.) to form CG.

The carboxylic acid functional groups present on the GO or CG may be used to covalently bond one or more metal chelating functional groups. The one or more metal chelating groups may comprise a carboxylic acid, a N-alkoxyamide, a hydroxamic acid, or a catechol moiety.

The carboxylic acid moiety of the metal chelating group may have the following structure according to Formula (I):

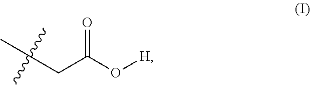

where the wavy line

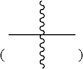

denotes attachment to the carboxylic acid functional group bound to the graphene scaffold.

The metal-chelating moiety of the metal chelating group may be a N-alkoxyamide moiety having a structure according to the following Formula (II):

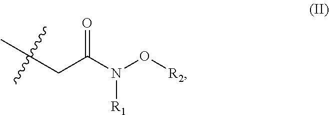

where the wavy line

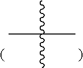

denotes attachment to a carboxylic acid functional group bound to the graphene scaffold; where R₁ may be a hydrogen or a C₁₋₆ alkyl; and R₂ may be —(CH₂)ₙ—CH₃, where n may range from 0 to 5. In one example, R₁ is hydrogen.

The metal-chelating moiety of the metal chelating group may be a hydroxamic acid moiety having a structure according to the following Formula (III):

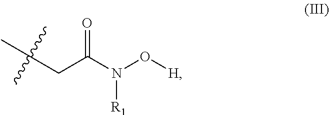

where the wavy line

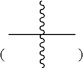

denotes attachment to the carboxylic acid functional group bound to the graphene scaffold; and where R₁ may be hydrogen or a C₁₋₆ alkyl. In one example, R₁ is hydrogen, as in hydroxamic acid.

The catechol moiety of the metal chelating group comprises the following 1,2-dihydroxybenzene structure according to Formula (IV):

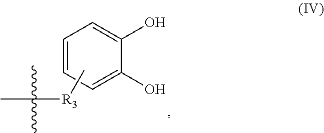

where the wavy line

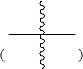

denotes attachment to a carboxylic acid functional group bound to the graphene scaffold; and where R₃ is a linking moiety for linking the 1,2-dihydroxybenzene group to the graphene scaffold. The linking moiety may be an organic moiety, optionally, having a total of ten or less C, O, and N atoms and, optionally, comprising an amide group, such as, an alkylamide linker having from three to six carbon atoms. The catechol moiety may be an N-[2-(3,4-dihydroxyphenyl)ethyl] amide moiety having the following structure:

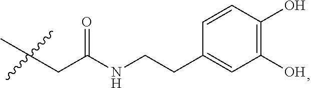 [SMILES: *CC(=O)NCCc1ccc(O)c(O)c1]

The graphene scaffold may be first oxidized to produce graphene oxide, which can comprise epoxide, carbonyl, carboxyl, and hydroxyl functional groups, with carbonyl groups located at the edge of the graphene. Graphene oxide may be further processed to produce Claisen graphene, which comprises pendant carboxyl groups on the basal plane. Pendant carboxyl groups of the graphene oxide or Claisen graphene may serve as chelating groups, or the carboxyl groups may be further modified to produce pendant hydroxamic acid or catechol groups that serve as chelating groups. To add hydroxamic acid or catechol functionality to the graphene scaffold, the graphene oxide or Claisen graphene may be reacted with a compound that comprises a functional group that is reactive with carboxylic acid functional groups, and/or other functional groups, such as, carbonyl, alcohol, or epoxide groups, of the graphene scaffold. For example, and without limitation, an amine group will form an amide bond when reacted with a carboxyl group of the GO or CG. The compound and the graphene scaffold are reacted under conditions such that the molecule covalently bonds to the graphene scaffold through a carboxylic acid reactive group to form the FGM having metal chelating properties. The compound and the carboxyl groups of the graphene scaffold also may be reacted using coupling reagents, such as, thionyl chloride or carbodiimides.

Suitable molecules that may be used to form a covalently bonded metal chelating functional group comprising a N-alkoxylamide moiety according to Formula (II) include, but, are not limited to, methoxyamine, ethoxyamine, N-methoxymethylamine, N-ethoxymethanamine, N-methoxypropan- 1-amine, N-methoxybutan-1-amine, N-ethoxyethanamine, O-tert-butylhydroxylamine, and salts thereof. The nucleophilic amine functional group of the molecule reacts with the electrophilic carbon of the carboxylic acid functional group of the graphene scaffold to form a covalent amide bond.

Suitable molecules that may be used to form a covalently bonded metal chelating functional group comprising a hydroxamic acid moiety according to Formula (III) include, but are not limited to, hydroxylamine and salts thereof. The nucleophilic amine functional group of the molecule reacts with the electrophilic carbon of the carboxylic acid functional group of the graphene scaffold to form a covalent amide bond.

Suitable molecules that may be used to form a covalently bonded metal chelating functional group comprising a catechol moiety to the graphene scaffold include, but, are not limited to 3,4-dihydroxybenzylamine, D-3,4-dihydroxyphenylalanine, L-3,4-dihydroxyphenylalanine, dopamine, tyrosine, noradrenaline, adrenaline, 5-hydroxydopamine, or 6-hydroxydopamine The amine functional group of these molecules may react with the carboxylic acid functional group of the graphene scaffold to form a covalent amide bond or a hydroxyl group of these molecules may react with the carboxylic acid functional group of the graphene scaffold to form an ester bond.

The one or more metal chelating groups covalently bound to the graphene scaffold are metal chelators. The metal-chelating groups may be chelators of aluminum (Al); heavy metals, such as, lead (Pb) and mercury (Hg); transitions metals such as, iron (Fe) and manganese (Mn); rare earth metals, such as, cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y), or any combination thereof. The metals to be chelated are present as metal ions. These metal ions can come from any source, such as, metal particles, metal nanoparticles, metal particulate precipitates, or any combination thereof. In the context of AMD, the FGMs may be particularly suitable as chelators of aluminum.

Metal ions may be reversibly bound to the one or more metal chelating functional groups of the FGM. The reversible binding of metal ions to the one or more metal chelating functional groups on the graphene scaffold forms a chelate. As used herein, “chelate” is a complex that is formed between a metal ion and a metal chelating functional group. The metal ion may be eluted from the chelate, thereby, regenerating the chelating functionality of the FGM and, optionally, recovering chelater metal, by washing the FGMs in acid, such as, nitric acid, to reform the graphene scaffold having one more metal chelating functional groups covalently bonded thereto. Prior to elution, the FGM may be washed under conditions in which the metal remains complexed to the metal-chelating functional group, such as, by washing the FGM with deionized water having a pH of 7. The metal ions may then be eluted from the FGM with acid to remove the chelated metal ion and to regenerate the chelating functionality of the graphene scaffold having one or one more metal chelating functional groups covalently bonded thereto.

Depending on the density of the chelating groups on the graphene scaffold, the FGM, when added to an aqueous liquid comprising dissolved metal, may chelate up to 30 micrograms metal per milligram (μg/mg) of the FGM, such as, up to 25 μg/mg of the FGM, such as, up to 20 μg/mg of the FGM.

The FGMs of the present application may further include magnetic nanoparticles linked thereto to form a magnetic FGM. As used herein, a “magnetic FGM” is a functional graphene material having one or more covalently bonded metal chelating functional groups and one or more magnetic nanoparticles linked to a graphene scaffold. The magnetic nanoparticles may comprise iron, cobalt, nickel, copper, zinc, strontium, barium, or a combination thereof. The magnetic nanoparticles may be linked to the graphene scaffold by any useful linking chemistry. Thereby, a magnet may be used to remove the FGM scaffold from treated liquid or sediment, after metal chelation. Magnetic beads may also be used in any washing step or eluting step to physically remove and manipulate the attached FGM.

A metal chelating composition comprising a graphene scaffold having one or more metal chelating functional groups covalently bonded to the graphene scaffold and a substrate. The substrate may be porous to increase available surface area and, therefore, the density of chelating groups. A “porous structure” may be a three-dimensional material comprising the metal-chelating FGM and having pores that are large enough to allow water to pass into or through the structure. To produce a porous structure, the FGM may be formed into a porous mass. Alternatively, the FGM may be combined with a porous substrate, thereby, providing the porous structure. The FGM may be covalently linked to, or non-covalently complexed with the porous substrate. Suitable porous substrates include, without limitation: a clay, a rock, a polysaccharide, a polymer, a ceramic, a carbon allotrope, such as, graphene, or any combination thereof. The polymer may be a non-degradable polymer. The porous substrate may be insoluble in an aqueous liquid, but, can be water-swellable. The porous substrate may be insoluble in acidic aqueous liquids. The porous substrate may be flexible or rigid.

The FGM described herein may be used to form a porous substrate. The FGMs may be used to form the porous substrate, such as, by compressing, casting, or cross-linking the FGMs into a desired shape and size. The porous structure may be formed by blending the FGMs with a clay, a rock, a polysaccharide, a polymer, a ceramic, graphene, or a combination thereof, followed by compressing, casting, or cross-linking the porous structure materials into the desired shape and size. The FGMs may be affixed to a porous substrate, where the porous substrate comprising a clay, a rock, a polysaccharide, a polymer, a ceramic, graphene, or a combination thereof. For example, the FGMs be affixed to the porous substrate through covalent linking, or non-covalent complexation. FIG. 2 provides a schematic depiction of a porous substrate 1 and an FGM 2 attached thereto, such as, through a coating. The porous substrate 1 may comprise a sheet, mesh, or non-woven material. The porous substrate 1 may comprise a three-dimensional structure, such as, a substrate in the shape of a stone or a rock. The porous substrate 1 comprising the FGM 2 may be insoluble in water. The porous substrate 1 comprising the FGM 2 may be used as a three-dimensional filter for water filtration and purification. In use, as described elsewhere, the porous substrate comprising the FGM may be washed to remove or recover any chelated metal.

In use, the FGM may be used to remove dissolved metals from an aqueous liquid. The FGM may be added to the aqueous liquid as a compound. The FGM may be added to an aqueous liquid as part of a porous structure comprising the FGM, for example, the FGM may be affixed to a porous substrate or the FGM may be physically arranged into a porous substrate. The dissolved metals that can be removed from the aqueous liquid by the FGM include those described above. The aqueous liquid may be drinking water or wastewater. The aqueous liquid may be neutral having a pH of 7. The aqueous liquid may be acidic having a pH of less than 7, such as, less than or equal to 6, such as, less than or equal to 5, such as, less than or equal to 4, such as, less than or equal to 3, such as, less than or equal to 2, or such as, less than or equal to 1. The aqueous liquid may be acid mine drainage.

The FGMs of the present invention may be used for the removal of aluminum from acid mine drainage. For example, the FGM may be directly added to water supplies, such as, stream beds, ponds, lakes, or reservoirs. The insolubility and settling of the FGM could be capitalized upon to recover materials from these water supplies, such as, stream beds having acid mine drainage.

The following examples are presented to demonstrate the general principles of the invention. The invention should not be considered as limited to the specific examples presented.

### EXAMPLES

### Materials and Methods

### Synthetic Methods

Graphene Oxide Synthesis Graphene oxide (GO) was synthesized using a modified Hummer's method. In a 1 liter (L) Erlenmeyer flask, 5 grams (g) of graphite flakes (graphite flake, natural, -325 mesh, 99.8% metal basis; Alfa Aesar, Ward Hill, Mass., USA) were added to 125 milliliters (mL) of concentrated sulfuric acid (Fisher Scientific, Pittsburgh, Pa., USA). The mixture was placed into an ice bath and allowed to stir. Potassium permanganate (KMnO₄; Sigma-Aldrich, St. Louis, Mo., USA) was added slowly to the mixture over a 20-30 minute (min) time period. Once all the KMnO₄ was added, the mixture was removed from the ice bath. After reaching room temperature, the mixture was stirred for 2 hours. The mixture was then heated gently to 35° C. and stirred for another 2 hrs. The heat was removed, and the reaction was quenched by the addition of 700 mL of deionized (DI) water, 10 mL of 30% hydrogen peroxide (Fisher Scientific), and an additional 225 mL of DI water. The reaction was left to stir overnight.

GO was purified by vacuum filtrating through a Buchner funnel. The GO disc was carefully removed from the funnel without scrapping the filter paper. Then, the GO disc was loaded into 3500 molecular weight cutoff dialysis tubing (SnakeSkin™ dialysis tubing, Thermo Scientific, Waltham, Mass., USA) and was dialyzed against 500 mL of DI water for 3-7 days. The DI water was changed until it became clear. After 3-7 days, the GO was removed from the dialysis tubing and placed into a tube. The GO was frozen at −80° C. and lyophilized for 3-5 days until dry.

Claisen Graphene Synthesis: In a flame dried round bottom flask under nitrogen, 1.94 g of GO (2:1 ratio) was added to 400 mL of triethyl orthoacetate (Alfa Aesar, Haverhill, Mass., USA). The reaction was bath sonicated (240 Watts, 42 kiloHertz (kHz) ultrasonic cleaner, Kendal) for 10 min. After sonication, 37.5 mL of p-toluene sulfonic acid was added to the mixture. The reaction was refluxed at 142° C. under nitrogen and stirred. After 36 hours (hrs) of refluxing, the heat was removed and the reaction was allowed to cool. When the reaction reached approximately 85° C., 50 mL of 1.0 molar (M) sodium hydroxide (NaOH) (in ethanol) was added with rapid stirring. At room temperature, the reaction was stirred for an additional 3 hrs.

CG was purified by vacuum filtration using a Buchner funnel. Without scrapping the filter paper, the CG disc was carefully removed from the funnel. The CG disc was dispersed in DI water, centrifuged at 4200 times gravity (x g) for 5 min, and the supernatant was discarded. The disc was washed 3 more times with DI water and 2 times with acetone. The disc was dried under vacuum for 1-2 days.

Hydroxamic Acid Functional Graphenic Material Synthesis: Hydroxamic acid FGMs were prepared with either GO or CG, generating hydroxamic acid GO (HA-GO) or hydroxamic acid CG (HA-CG), respectively. Briefly, a round bottom flask was charged with 100 milligrams (mg) of either GO or CG and 100 mL of dimethyl sulfoxide (DMSO) under atmospheric conditions. The reaction mixture was sonicated for 10 min to disperse the graphenic component followed by the addition of 500 mg of 1-ethyl-3-(3-dimethylaminopropyl)carbodiimide (EDC; Oakwood Chemicals, Estill, S.C., USA). After 10 min of stirring at room temperature, 330 mg of N-Hydroxysuccinimide (NHS; Chem-Impex International, Wood Dale, Ill., USA) was added and stirred for an additional 10 min at room temperature. Then, 100 mg of hydroxylamine hydrochloride (Sigma—Aldrich, St. Louis, Mo., USA) was added using a solution of 500 milligrams per milliliter (mg mL⁻') of hydroxylamine hydrochloride dissolved in 7.2 M NaOH (Fisher Scientific, Hampton, N.H., USA). The reaction mixture was stirred overnight at room temperature.

To isolate the graphenic component, the reaction was centrifuged at 3600×g for 5 min to pellet the graphenic component, discarding the supernatant. Then, the reaction product was purified with a series of wash steps, where the graphenic pellet was re-dispersed in DI water via vortexing and centrifuged for 5 min at 3600×g. The supernatant was discarded. The washing procedure was repeated with DI water three additional times, followed by two washes with acetone. The graphenic pellet was dried under vacuum for 24-48 hours until dry.

Catechol Functional Graphenic Materials: Catechol GO (CGO) and catechol CG (CCG) were prepared through an acyl chloride intermediate. In a flame dried round bottom flask under nitrogen, 100 mg of GO or CG, 50 mL dry dioxane, and 10 drops of dimethylformamide were added. The mixture was bath sonicated for 10 min After sonication, 1.4 mL of thionyl chloride (Sigma-Aldrich, St. Louis, Mo., USA) was slowly added dropwise to the mixture. The reaction was stirred overnight at room temperature.

The next day, 500 mg of 3,4-dihydroxybenzylamine (DHBA) (Sigma-Aldrich, St. Louis, Mo., USA) was added to the flask. The reaction was heated to 100° C. under nitrogen and was stirred overnight. The reaction was removed from heat and allowed to cool to room temperature. The reaction was centrifuged at 4200 x g for 5 min The graphenic component was pelleted and the supernatant was discarded. The pellet was washed in dichloromethane and centrifuged at 4200×g for another 5 min and the supernatant discarded. The washes were repeated once more with dichloromethane, twice with DI water, and twice with acetone. The graphenic pellets were dried under vacuum for 1-2 days.

### Material Characterization

Fourier Transform Infrared (FTIR) Spectroscopy: FTIR spectra of the graphenic chelator materials were collected on a PerkinElmer Frontier FT-IR Spectrometer with an attenuated total reflectance (ATR) attachment containing a germanium crystal. Raw spectra were recorded from 4000-700 inverse centimeters (cm⁻¹) with a 4 cm⁻¹ resolution. All spectra were ATR, smoothed by a smooth value of 50, and baseline corrected. Spectra were collected in % transmittance.

Thermogravimetic Analysis (TGA): TGA was performed on a PerkinElmer TGA 4000 under nitrogen (20 milliliters per minute (mL min⁻¹) flow rate). The samples were held at 50° C. for 15-30 min, and then heated from 50-800° C. with heating rate of 10° C. inverse minutes (min⁻¹). The data collected was analyzed in TRIOS software (TA instruments) to determine the onset temperature (T_{O}), endset temperature (T_{E}), weight loss percentage (%D), and first derivative temperature (T_{P}). The derivative of the thermograms were smoothed with a simple moving average (step size 50). Three measurements of T_{O} and T_{E} were determined from the thermograms by using the onset and endset functions in TRIOS. Using the values from the onset and endset temperatures, the %D was found from the first derivative using the area under the curve function in TRIOS and the values were averaged. Using the average of three measurements, the Tp was determined from the signal minimum of the first derivative of the thermogram.

Atomic Absorption Spectroscopy: FGMs were dispersed in 2 mL of a 50 parts per million (ppm) aluminum solution made in a pH 4 nitric acid solution, generating 1 mg mL⁻' dispersions. All samples were agitated for 1 hr on a rotating shaker (MiniMixer™, Benchmark Scientific, Sayreville, N.J., USA) to ensure homogeneity. FGM dispersions were then filtered and the resulting liquids were analyzed using a ThermoFisher iCE 3000 graphite furnace atomic absorption spectrometer. The instrument and autosampler were both set to furnace mode, and the samples were analyzed at a lamp current of 50% and a wavelength of 394.4 nanometers (nm). The bandpass was set to 0 2 millimeters (mm) half-height, the cuvette type was set to ELC (extended life cuvette), and the injection temperature was set to zero. In the event of any solution having an aluminum concentration that did not fit within the calibration curve of 300 to 700 parts per billion (ppb), the instrument was set to intelligently dilute the outlier sample using a fixed volume of solution to fit the curve.

X-ray Photoelectron Spectroscopy (XPS): XPS analysis was conducted on a Thermo Fisher ESCALAB 250 Xi instrument with an Al K-Alpha source gun and a flood gun in charge compensation standard mode. All spectra were collected using a standard lens mode (angle and field of view of 32000 steps), Constant Analyzer Energy (CAE) scan mode, and a 200 micrometer (μm) spot size. Powdered samples were prepared for XPS analysis using double-sided copper tape as the substrate. Samples were securely adhered to the double-sided copper tape to ensure complete coverage of the substrate without excess loose powder. Survey, C1s, and N1s spectra were collected in triplicate for each sample from three separate spot locations. One Al2p spectrum was collected.

Survey Scans: All survey scan spectra were collected using 5 cumulative scans over a binding energy range of 1350 to −10 electronvolts (eV). Further, all samples were analyzed using a pass energy of 150 eV, an energy step size of 1 eV, and a dwell time of 10 milliseconds (ms). CasaXPS software (CasaXPS) was used to quantify the elemental composition from survey spectra by integrating the area under peaks unique to each element. Specifically, the O1s (545-525 eV), N1s (410-392 eV), C1s (298-279 eV), Cl2p (210-190 eV), Br3p (194-172 eV), S2p (175-157 eV), and Al2p (80-68 eV) emission peaks were used to quantify oxygen, nitrogen, carbon, chlorine, bromine, sulfur, and aluminum, respectively. Additionally, a smart background and standard peak types were used for all elemental quantification. For each material, each survey spectra was collected from a separate spot locations to prevent artifacts from sample degradation.

High Resolution Carbon (C1is) Scans: All high resolution C1s spectra were collected using 10 cumulative scans over a binding energy range of 298 to 279 eV. Additionally, all spectra were acquired using a pass energy of 50 eV, an energy step size of 0.1 eV, and a dwell time of 50 ms. Each C1s spectra were collected from different spot locations to prevent artifacts from sample degradation. OriginPro (OriginLab) was used to smooth raw C1s spectra with the Savitzky-Golay smoothing method. Specifically, the Savitzky-Golay smoothing was carried out using a second—degree polynomial with a 15—point step—size. After smoothing, all spectra were charge corrected to adventitious carbon (284.8 eV) and truncated to 292-280 eV. Fityk (Version 0.9.8) software was used for Shirley baseline subtraction and Gaussian peak fitting. The peak locations for carboxylic acids (289.0 eV), ketones (287.4 eV), alcohols and epoxides (286.5 eV), and sp² and spa hybridized carbon (284.8 eV) were constrained to ±0.2 eV. The full width at half maximum (FWHM) for all peaks was constrained to 1.4 eV.

High Resolution Nitrogen (Nis) Scans: All high resolution N1s spectra were collected from 410 to 392 eV with 25 cumulative scans per spectra. Further, spectra were acquired using a pass energy of 50 eV, an energy step size of 0.1 eV, and a dwell time of 50 ms. Each N1s spectra was collected at a different spot location on the material to prevent sample degradation due to the X-ray source. OriginPro was used to smooth raw N1s spectra using the Savitzky-Golay method (second—degree polynomial) with a 25—point step—size. The N1s spectra were truncated to 405-395 eV. Fityk was then used to remove the Shirley background and deconvolute peaks using Gaussian peak fitting. For catechol FGMs, peak fitting procedures have already been established using appropriate standards. All peaks were constrained to ±0.2 eV of the peak location with a fixed FWHM. For amines, the peak location was 400.1 eV with a FWHM of 1.64 eV. The amide peak location was 398.8 eV with a FWHM of 2.30 eV.

High Resolution Aluminum (Al2p) Scans: All high resolution Al2p scans were acquired with 25 cumulative scans per spectra, a pass energy of 50.0 eV, an energy step size of 0.1 eV, and a dwell time of 50 ms. OriginPro was used to smooth raw Al2p spectra with the Savitzky-Golay method (second—degree polynomial) with a 45—point step—size. Spectra were truncated to 80-65 eV. Then, spectra were processed in Fityk, where the Shirley background was removed. Quantification of the area under the curve of Al2p for catechol FGMs (CGO and CCG) was also conducted in Fityk with Gaussian peak fitting. The Al2p spectra have spin-orbit splitting into 2p1 and 2p3 peaks; however, the 2p1 and 2p3 splitting is closely spaced (A =0.44 eV). CGO and CCG Al2p spectra had two, clearly separated peaks (A=˜3.0 eV). Thus, each peak was deconvoluted as one peak without spin-orbit splitting or peak constraints (peak location or FWHM). The peaks in the Al2p spectra for CGO were 70.7 eV (FWHM=2.44 eV) and 74.6 eV (FWHM=1.74 eV). The peaks in the Al2p spectra for CCG were 70.2 eV (FWHM=2.3 eV) and 74.4 eV (FWHM=2.32 eV). Quantification of each peak was determined from the area under the curve.

Energy-Dispersive X-ray (EDX) Spectroscopy: FGMs were prepared by adhering powders onto double sided copper tape to generate thick films. EDX was performed using a FEI Quanta 600. Thick films attached onto conductive copper tape were mounted and imaged at x600 and x2500 magnification under low vacuum with 20 kiloelectronvolts (keV) incident e-beam. Element mapping was conducted by detecting characteristic X-ray generated from surface.

Proton Nuclear Magnetic Resonance (¹H-NMR) Spectroscopy: Samples were prepared by dispersing 5 mg of FGMs in deuterated water (D₂O). The dispersions were vigorously vortexed and then filtered through a 0.2 μm syringe filter. The filter containing the FGMs was discarded while the filtrate was collected and analyzed via ¹H-NMR. A 500 MHz NMR was used to acquire spectra with 32 cumulative scans.

### FGM Aluminum Chelation and Regeneration Methods

Stability and Degradation

The graphenic chelator materials (GO, CG, HA-GO, HA-CG, CGO, and CCG) were split into four different centrifuge tubes. Each tube was label with week 1, 2, 3, or 4. To each tube, 1 mL of 1.0×10⁻⁴ M nitric acid solution (at pH 4) was added. After one week, the tubes labeled week 1 were centrifuged at 4200×g for 5 min and the supernatant was discarded. The materials were washed 2 times with acetone and the supernatant was discarded. The materials were dried under vacuum. The procedure was repeated for the week 2, 3, and 4.

### FGM Bacterial Culture

Aseptic technique was utilized when preparing and handling all samples to prevent contamination.

Buffered Media Preparation: Media was prepared using a modified method, where 12.5 g of LB Miller Broth (Fisher BioReagents™, USA) and 0.75 g of Tris HCl (Promega, Madison, Wis., USA) were dissolved in 500 mL of deionized water to generate a final media concentration of 10 grams per Liter (g L⁻¹) tryptone, 10 g L⁻¹ NaCl, and 5 g L⁻¹ yeast extract. Media was then sterilized at 121° C. for 1 hr in an autoclave. Media was cooled to room temperature before use.

Escherichia coli (E. coli) Bacterial Culture: E. coli strain K12 was purchased from ATCC (ATCC® 25404′). Cultures were maintained in 5 mL of buffered media in a 50 mL centrifuge tube with a loosened cap, on a rotating shaker (MiniMixer™, Benchmark Scientific, Sayreville, N.J., USA) at 37° C. (MyTemp Mini Digital Incubator, Benchmark Scientific). Cultures were propagated for 16 hr at 37° C., generating a cell concentration of approximately 2×10⁹ bacteria per milliliter. Then, bacteria were subcultured by centrifugation at 10000×g for 15 min to pellet the cells, followed by aspiration of the supernatant and resuspension of the pellet in 5 mL of fresh, buffered media. Cultures were then used for experiments in a 1:4 split ratio with fresh, buffered media (1 mL stock cell suspension: 4 mL fresh, buffered media).

FGM Stock Dispersions: FGMs were weighed into 20 mL glass scintillation vials and irradiated with 254 nm ultraviolet light for 5 min for sterilization. Powders were dispersed in buffered media (sterilized, buffered LB Miller Broth) to a final concentration of 2.00 mg mL⁻¹. Then, the FGM 2.00 mg mL⁻'stock dispersion was serially diluted to generate 0.20 and 0.02 mg mL⁻¹ FGM dispersions.

LIVE/DEAD® BacLight™ Assay: All samples were run in triplicate, except for the negative control, where five negative control samples were run to ensure enough bacterial culture was available to generate a calibration curve the LIVE/DEAD® BacLight™ Bacterial Viability Kit (ThermoFisher Scientific, Waltham, Mass., USA). Samples (containing 250 microliters (pL) per well) were prepared in the interior wells of a 96-well cell culture plate to prevent evaporation over the course of the experiment. All samples contained 4% volume per volume (v/v) E. coli from the 1:4 split ratio of the bacterial stock. Negative controls and positive controls were run in conjunction with the FGM samples. The negative controls were not treated and only contained E. coli and media while the positive controls were dosed with Penicillin/Streptomycin diluted to 100 U mL⁻¹ (ThermoFisher Scientific). The FGM samples were prepared by dosing E. coli with FGM stock dispersions (2.00, 0.20, 0.02 mg mL⁻¹) to final concentrations of either 1.00, 0.10, or 0.01 mg mL⁻¹. Finally, the 96-well cell culture plate (with cell culture plate lid) was incubated at 37° C. on a rotational shaker for 16 hrs.

After a 16 hr incubation, the 96-well culture plate was removed from the rotational shaker and the 37° C. incubator. The plate was placed on a flat surface and undisturbed for 15 min at room temperature to ensure FGMs settled to the bottom of wells. Then, 125 μL was removed from each well (with care taken to leave FGMs on the bottom of the wells) and used for the LIVE/DEAD® BacLight™ assay. The remainder of the volume in the 96-well culture plate containing the FGMs was also collected for material analysis described below.

A modified procedure for the microplate LIVE/DEAD® BacLight™ assay was used (Saha, S. et al. Assessment of Hazard on Human Health and Aquatic Life in Acid Mine Drainage Treated with Novel Technique. Human and Ecological Risk Assessment: An International Journal 2019, 25 (8), 1925-1941). That is, the 125 μL aliquots obtained from the 96-well culture plate were centrifuged (Eppendorf Microcentrifuge Model 5430) at 10000×g for 10 min to pellet bacteria. The pelleted bacteria were an opaque white and did not contain noticeable FGMs. The supernatant consisting of media was carefully removed without disturbing the pelleted bacteria. Bacterial pellets were gently re-dispersed in 1.0 mL of 0.85% sodium chloride (NaCl) buffer for all samples except two samples out of five samples of the negative control. The remaining two negative control samples were used to generate the calibration curve. One sample was re-dispersed in 1.5 mL of 0.85% NaCl buffer and designated the 100% live sample. The second negative control sample was designated as the 0% live sample and dispersed in 0.5 mL of 0.85% NaCl buffer and 1.0 mL of 70% isopropyl alcohol. The 100% and 0% live sample were incubated for 1 hr at room temperature and inverted every 15 min After the 1 hr incubation, the samples were centrifuged at 10000 x g for 10 min, the supernatant discarded, and carefully re-dispersed in 1.0 mL of 0.85% NaCl buffer. The 100% and 0% live were then used to create 90%, 50%, and 10% live samples for the calibration curve.

After all samples were prepared and dispersed in 0.85% NaCl buffer, 100 μL of each sample was loaded into a 96-well culture plate and absorbance at 670 nm was acquired on a Spark® plate reader (Tecan) with SparkControl™ v2.2 software. Samples were diluted with 0.85% NaCl buffer, accordingly, to reach an optical density at 670 nm of 0.06.

The LIVE/DEAD® BacLight™ stain was prepared by dispersing 3 μL of Syto® 9 and 3 μL of propidium iodide for every 2 mL of deionized water. Then, 100 μL of stain was added into each well of the 96-well culture plate containing 100 μL of sample. The plate was protected from light and incubated for 15 min at room temperature.

Fluorescence spectra for all samples stained with the LIVE/DEAD® BacLight™ assay were collected on a Spark® plate reader with SparkControl™ v2.2 software. All spectra were acquired with a manual gain of 60 from a z-position of 17,152 μm, an excitation wavelength of 470 nm with a bandwidth of 10 nm, and an emission spectrum from 500-700 nm was collected with a bandwidth of 10 nm and 5 nm step size.

Fluorescence microscopy samples were collected using an EVOS® FL Auto Cell Imaging System (ThermoFisher Scientific) with a 100×, 1.40 numerical aperture, oil-immersion objective. Samples were prepared by depositing 10 μL of stained bacterial onto a 25×75 mm, 1.0 mm thick microscope slide. After depositing bacterial samples, samples were left for 2-5 minutes on a flat surface to allow bacteria to settle onto the microscope slide for co-localization fluorescence imaging.

LIVE/DEAD® BacLight™ Assay FGM Control Experiment: To ensure that FGMs did not interfere with the LIVE/DEAD® BacLight™ assay, a control experiment was run. Six no treatment samples were cultured in a 96-well plate using the same procedure as described above. For each sample, 125 μL was removed from each well and centrifuged at 10000×g for 10 min to pellet bacteria. The buffered media was removed with care taken not to disturb the bacterial pellets. The pellets were then re-dispersed in 1.0 mL 0.85% NaCl buffer containing either 1.0, 0.10, 0.010, 0.0010, 0.00010, or 0.0 mg mL⁻¹ of GO or CG. Then, 100 μL of samples were added to a 96-well plate and absorbance was measured. Further, samples were stained using the LIVE/DEAD® BacLight™ assay as described above and fluorescence emission spectra were acquired. An additional step prior to measuring absorbance spectra and fluorescence was added to ensure that FGMs were properly dispersed. That is, a 20 second orbital shaking step with an amplitude of 1.0 mm and frequency of 510 rpm was performed on the 96-well plate in the Spark® plate reader.

### Results and Discussion

Material Design Rationale: To design recoverable aluminum-chelating materials, (1) an insoluble graphenic scaffold and (2) aluminum-chelating groups that can be attached to the scaffold are needed (FIG. 1).

Graphenic Scaffolds: Functional graphenic materials (FGMs) were targeted as the scaffolds of interest due to the insolubility, settling, processability, high surface area, versatility of chemical manipulation, and spatial control of functional groups on the graphenic material. The insolubility, settling, and processability of FGMs enable recovery after use, and present the possibility for regeneration for reusable, aluminum-chelating materials for AMD remediation. AMD remediation with aluminum-chelating FGMs may be accomplished using at least two approaches. The first approach could encompass the direct addition to water supplies, where the insolubility and settling of FGMs could be capitalized upon to recover materials from stream beds. The second approach is the utilization of FGMs as a filter.

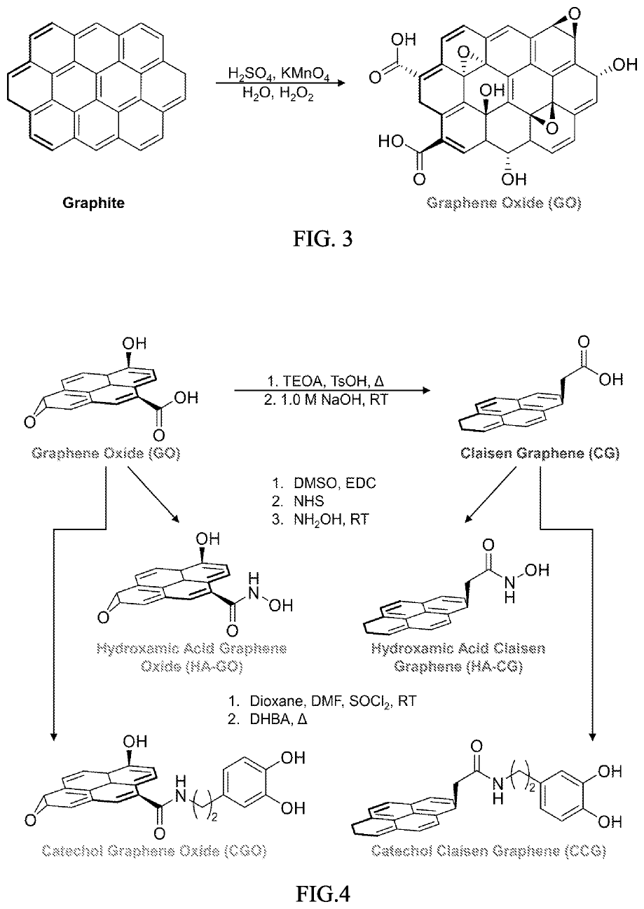

FGMs are ideal scaffolds due to their high surface area. These graphenic materials can be accessed inexpensively using graphite as a precursory material. Graphite is composed of two-dimensional sheets of carbon atoms bound together, where many sheets aggregate to form the bulk material. Using a modified Hummers' method (Dideikin et al.; Dideikin, A.T et al. Graphene Oxide and Derivatives: The Place in Graphene Family. Front. Phys. 2019, 6; Arnold, A. M. et al.), the large surface area of graphite sheets is exposed through exfoliation and installation of oxygen groups, yielding atomically thin sheets of graphene oxide (GO) (FIGS. 1 and 3).

The plethora of functional groups found on GO creates an opportunity for versatile chemical manipulation and spatial control of functionality on the graphenic backbone. GO contains spatially separated, distinct oxygen groups that serve as excellent chemical handles for targeted functionalization on either the edge or the basal plane of sheets (FIGS. 1 and 4). The edges of GO sheets are populated by carboxylic acids while the basal plane of GO contains tertiary alcohols and epoxides. To target edge functionality, carboxylic acids on the edge of GO sheets can be activated to produce hydroxamic acid and catechol edge functionalized FGMs. Conversely, to target basal plane functionality, the tertiary alcohols found on the basal plane of GO can be transformed into carboxylic acids via a Johnson-Claisen rearrangement, producing an FGM known as Claisen graphene (CG) (FIG. 4). These basal plane carboxylic acids found on CG can then be manipulated using the same chemistries as GO, enabling the production of basal plane functionalized FGMs (FIG. 4).

Aluminum-chelating Groups: Hard soft acid base (HSAB) theory was employed to identify functional groups that bind aluminum. Using HSAB theory, acids and bases are divided into hard and soft designations, where hard classifications include small, highly charged species, and soft classifications include large species with low charge. According to HSAB theory, hard acids form more stable compounds with hard bases, and soft acids form more stable compounds with soft bases. Aluminum is a hard acid; thus, chemical moieties classified as hard bases that have been previously reported to chelate aluminum were targeted and include: carboxylic acids, hydroxamic acids, and catechols (Barron, A. R. The Interaction of Carboxylic Acids with Aluminium Oxides: Journeying from a Basic Understanding of Alumina Nanoparticles to Water Treatment for Industrial and Humanitarian Applications. Dalton Trans. 2014, 43(22): 8127-8143; Yokel, R. A. Aluminum Chelation: Chemistry, Clinical, and Experimental Studies and the Search for Alternatives to Desferrioxamine Journal of Toxicology and Environmental Health 1994, 41(2): 131-174; U.S. Pat. No. 9,259,670 B2) (FIG. 1).

Generation of Aluminum-chelating FGMs: Facile chemistries that install the identified aluminum-chelating groups (carboxylic acids, hydroxamic acids, and catechols) on either the edge or basal plane of the graphenic scaffolds, generating six aluminum-chelating FGMs were demonstrated.

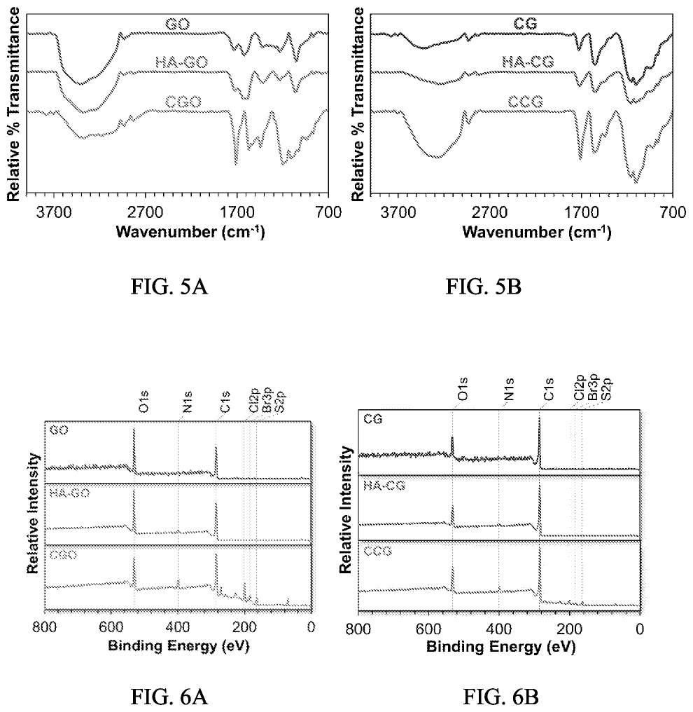

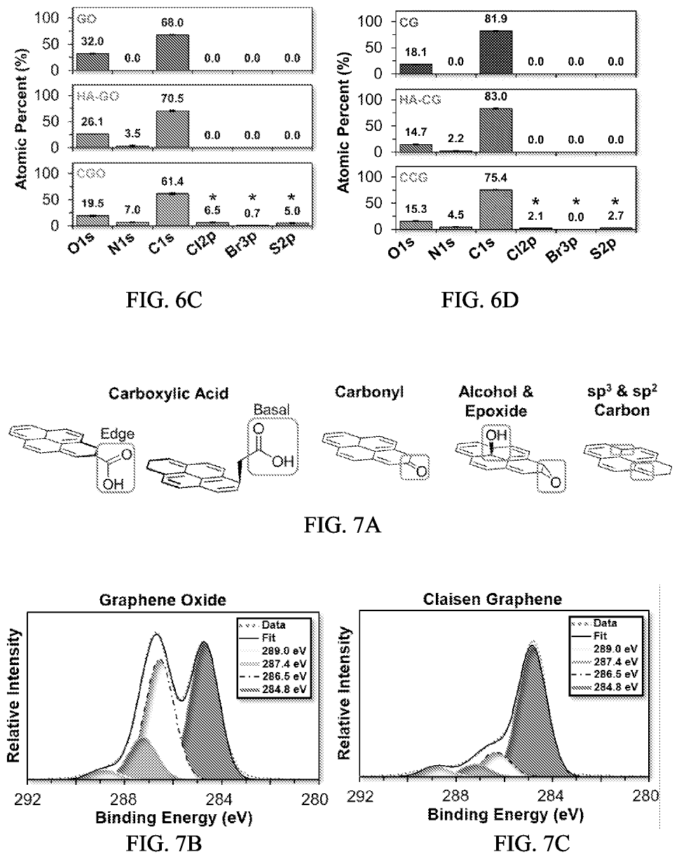

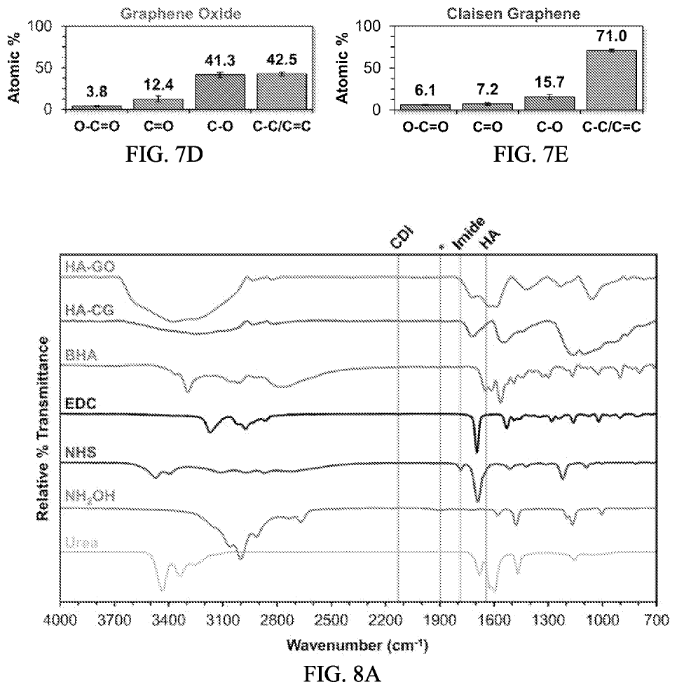

Carboxylic Acid Functionalized FGMs: FGMs containing carboxylic acids on the edge or basal plane of flakes were successfully synthesized, yielding graphene oxide (GO) and Claisen graphene (CG), respectively. Fourier transform infrared (FTIR) spectroscopy demonstrates that GO (FIG. 5A) and CG (FIG. 5B) contain a carboxylic acid stretch at 1720 cm⁻¹. Deconvolution of high-resolution carbon spectra obtained from X-ray photoelectron spectroscopy (XPS) also reveals a carboxylic acid peak at 289.0 eV for both GO and CG (FIGS. 6A-6D; FIGS. 7A-7E).

Hydroxamic Acid Functionalized FGMs: Edge functionalized hydroxamic acid GO (HA-GO) and basal functionalized hydroxamic acid CG (HA-CG), using carbodiimide activation of carboxylic acids on GO and CG, respectively, were produced (FIG. 4). This represents one of the first times hydroxamic acids have been installed on a graphenic material. To confirm that hydroxamic acids were covalently installed on the edge and basal plane of graphenic sheets, a multifaceted characterization approach including XPS, FTIR spectroscopy, and proton nuclear magnetic resonance (¹H-NMR) spectroscopy was used.

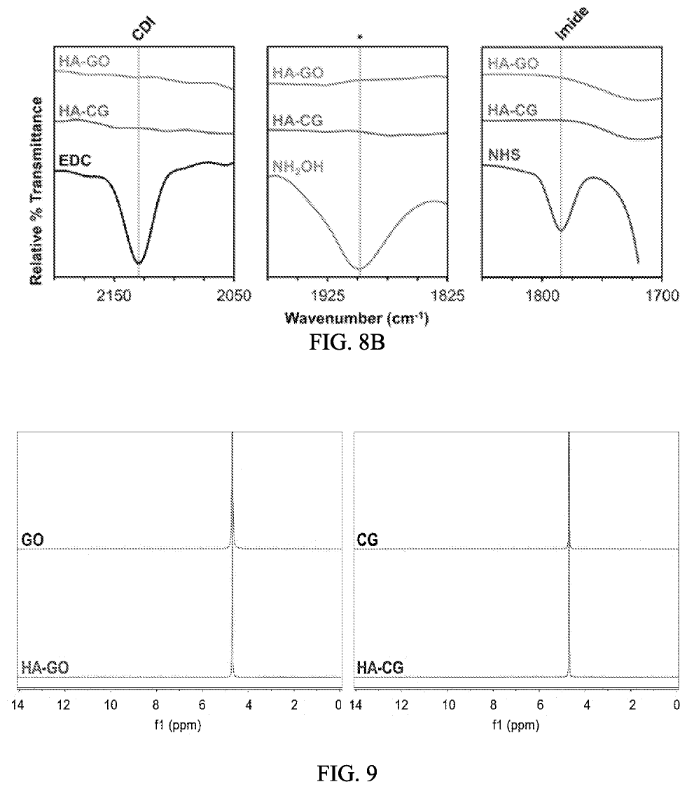

Elemental XPS confirmed hydroxamic acid FGMs contained nitrogen (FIGS. 6A-6D), which is an element unique to hydroxamic acids. However, reagents used to synthesize HA-GO and HA-CG and the resulting byproducts of the reaction also contain nitrogen. For example, EDC, NHS, and hydroxylamine (NH₂OH) were reagents necessary to synthesize HA-GO and HA-CG and all contain nitrogen. Further, the urea byproduct from the carbodiimide coupling also contains nitrogen. Thus, XPS high resolution N1s analysis and Fourier transform infrared (FTIR) spectroscopy were utilized to try to identify the chemical state of the nitrogen signal in the HA-GO and HA-CG materials. The hydroxamic acid moieties in HA-GO and HA-CG did not produce a unique peak in the XPS high resolution N1s spectra. Further, the hydroxamic acid stretch (1650 cm⁻¹), which was determined using benzohydroxamic acid as a standard, overlapped with other stretches from the graphenic backbones (FIGS. 8A-8B). A variety of analytical techniques were used to show that HA-GO and HA-CG did not contain any residual reagents or byproducts from the synthesis, suggesting the nitrogen content was a result of hydroxamic acids.

Further, the nitrogen content of HA-GO and HA-CG was consistent with the number of carboxylic acids on GO and CG that could be used for functionalization. FTIR spectroscopy was utilized to determine the presence of impurities (either reagents or byproducts from synthesis) in HA-GO and HA-CG. As shown in FIGS. 8A-8B, HA-GO and HA-CG did not contain a carbodiimide (CDI), imide, or NH₂OH stretch denoted as *, indicative of the presence of EDC, NHS, and NH₂OH, respectively. A model urea compound did not contain any unique stretches in the FTIR spectra.

Proton nuclear magnetic resonance (¹H-NMR) spectroscopy was utilized to confirm that the urea byproduct was not contributing to the nitrogen signal in the HA-GO and HA-CG materials (FIG. 9). All of the nitrogen-contain reagents and byproducts are water soluble. Thus, FGMs were dispersed in D₂O and vigorously mixed to remove impurities from the graphenic backbones. The graphenic component was removed via filtration and the filtrate containing any water-soluble impurities was analyzed. The spectra show that there was no measurable urea byproduct, EDC, or NHS. Thus, the nitrogen content detected in the hydroxamic acid FGMs via XPS was a result of hydroxamic acid functionalization of the graphenic backbone.

Catechol Functionalized FGMs: Edge and basal plane functionalization of graphenic materials with catechol moieties was also accomplished using carbodiimide chemistry. Arnold et al. previously reported the successful synthesis of catechol GO (CGO) and catechol CG (CCG). Briefly, carbodiimide activated carboxylic acids on GO and CG are coupled to an amine-containing catechol, generating an amide linkage between the graphenic backbone and the catechol.

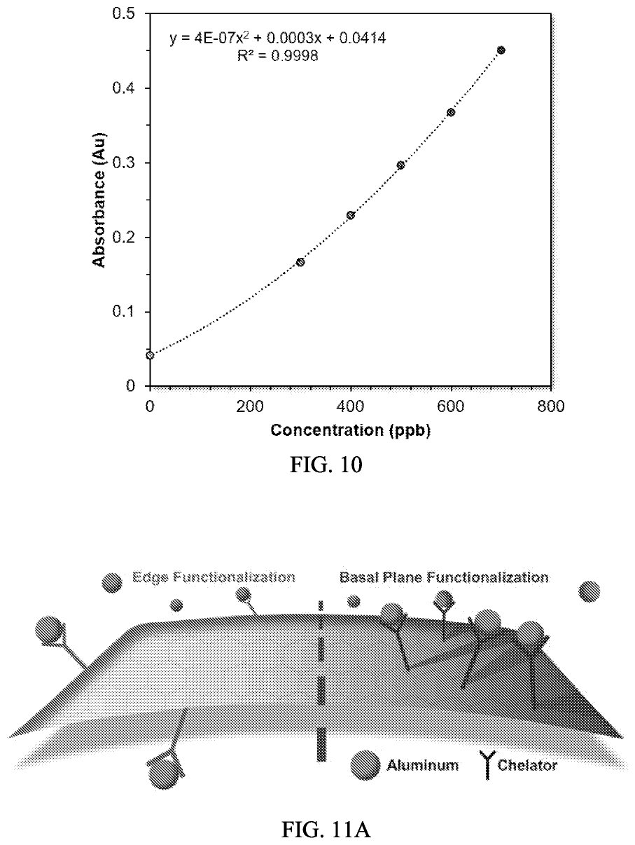

CGO and CCG were successfully coupled with catechol. FTIR spectroscopy shows the characteristic carboxylic acid stretch at 1720 cm⁻¹ for GO and CG. After catechol conjugation, the carboxylic acid stretch shifts to 1705 cm⁻¹ and increases in intensity for CGO and CCG, suggesting the formation of an amide bond (FIGS. 5A-5B). Further, an element unique to the catechol molecule (nitrogen) was detected by XPS in CGO and CCG (FIGS. 6A-6D). Deconvolution of XPS high resolution nitrogen spectra showed the presence of an amide peak at 398.8 eV for CGO and CCG (FIG. 10), confirming that some of the catechol molecules in CGO and CCG were covalently bound to the graphenic backbone.

The catechol FGMs contained some impurities from the synthetic method (sulfur, chlorine, and bromine) (FIGS. 6A-6D). Impurities can adversely affect bacterial compatibility. However, it was demonstrated that our FGMs are tolerated by E. coli even in high concentrations of catechol FGMs. This observation contrasts previous work demonstrated moderate antimicrobial capacity. However, there were significantly less impurities in the FGMs utilized for this study, which may explain the enhanced tolerance of E. coli cultures with catechol FGMs.

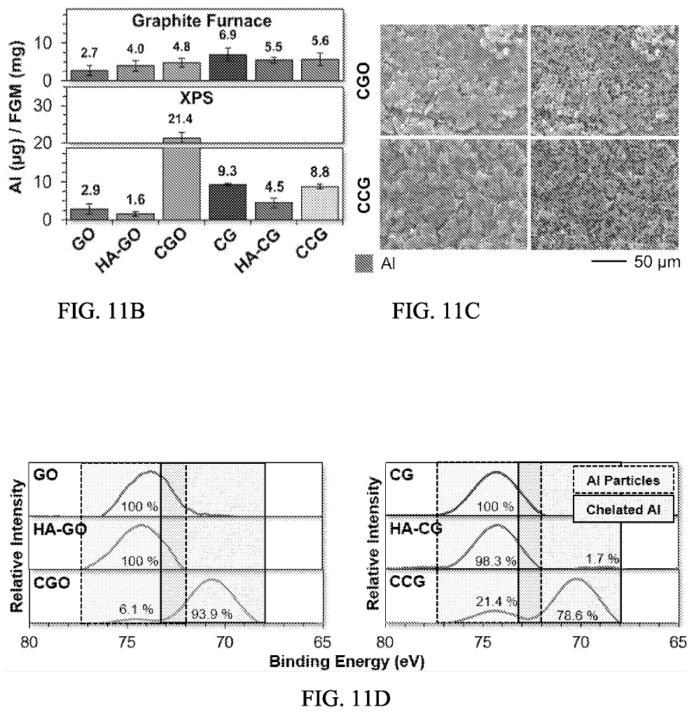

Chelation Capacity and Regeneration of FGMs: All six of our FGMs chelated aluminum in AMD-like condition. Here, FGMs were exposed to acidic water contaminated with high concentrations of aluminum for one-week and the capability of FGMs to chelate aluminum was confirmed using two approaches. One method analyzed the amount of aluminum removed from solution using a graphite furnace (FIG. 11A). The second method analyzed the amount of aluminum on the recovered FGMs via XPS (FIGS. 11A and 11C) and energy-dispersive X-ray (EDX) spectroscopy (FIG. 11B). While the graphite furnace analyzes bulk samples and XPS examines surface properties, these results corroborate FGMs have the capacity to remove up to 21 μg of aluminum per mg (μg/mg) of FGM.

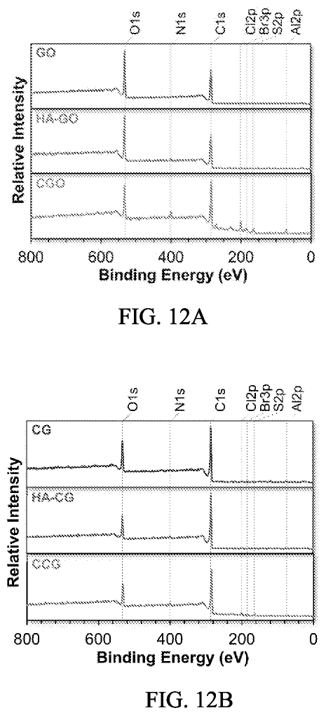

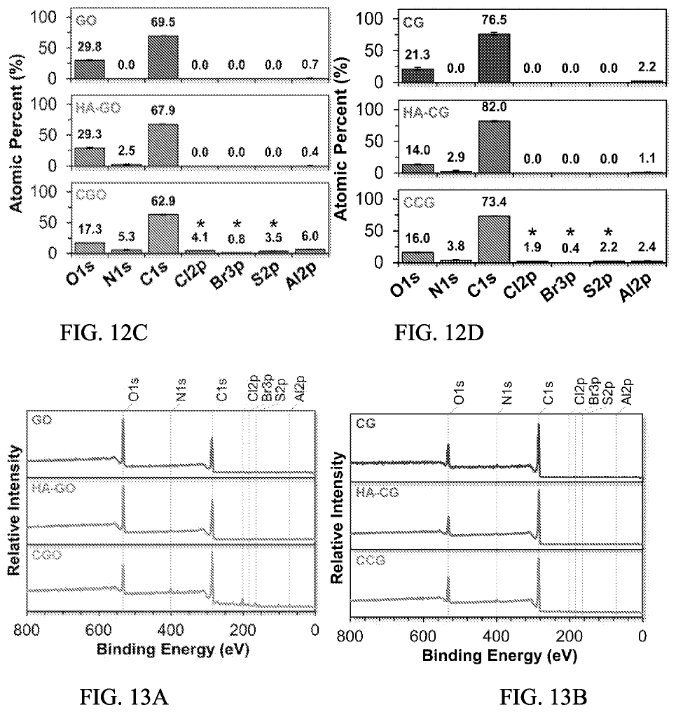

The aluminum chelation capacity of FGMs is influenced by the location and identity of chemical moieties on the graphenic scaffold. Graphite furnace and XPS analyses suggest that basal functionalized FGMs chelate more aluminum than edge functionalized materials (FIGS. 10, 11A-11D, 12A-12B). The advantage of basal plane functionalization may be a result of intersheet chelation, which is less favorable for edge functionalized FGMs. Further, CG, CGO, and CCG containing carboxylic acid and catechol moieties, chelated the most aluminum (up to 21.4 μg/mg for CGO). In AMD, the aluminum concentration can vary over orders of magnitude across sites, as well as seasonally at the same site (Naidu, G. et al. A Critical Review on Remediation, Reuse, and Resource Recovery from Acid Mine Drainage. Environmental Pollution 2019, 247: 1110-1124).

High resolution aluminum XPS demonstrates that aluminum is removed in different chemical forms by FGMs. All six FGMs removed aluminum as aluminum particles due to a characteristic peak at 74.5 eV (FIG. 11D). We hypothesize that oxygen groups on the edge and basal plane of FGMs may serve as nucleation sites for aluminum precipitation. CGO and CCG also contained a peak at 74.5 eV, indicating the materials also promoted aluminum precipitation. However, catechol FGMs also had a more predominant peak at 70.5 eV resulting from chelated aluminum ions.

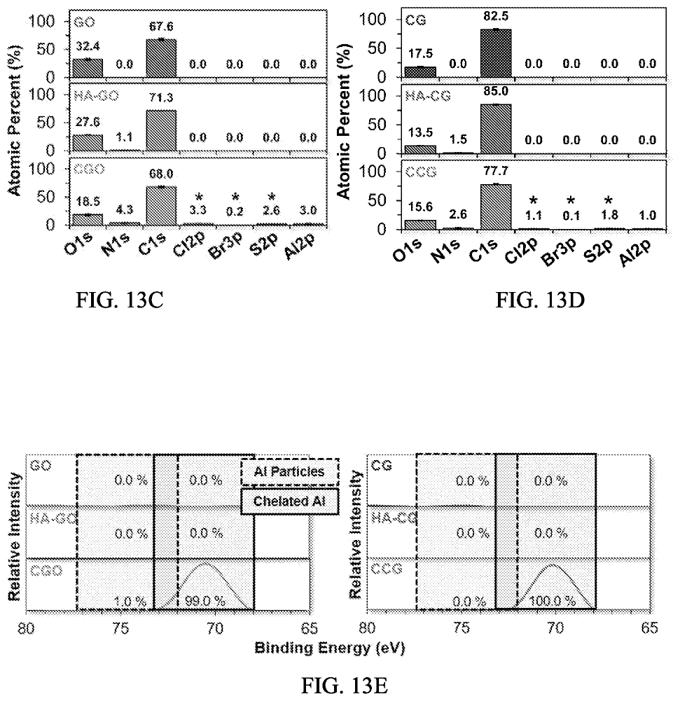

The reversibility of chelation to was tested to determine if FGMs could be regenerated for reuse (FIGS. 13A-13D). Aluminum was sequestered in two forms on FGMs: as aluminum ions, held in coordination complexes, and as particulate precipitates. Aluminum was completely removed from edge- and basal-modified FGMs containing carboxylic and hydroxamic acids. However, only 49% and 57% of aluminum was removed from CGO and CCG, respectively. In these FGMs, all particulate aluminum was removed, but, the ionic aluminum remained, demonstrating the irreversibility of the chelation bond with catechol groups. This was confirmed by the 70.5 eV peak in the high resolution XPS aluminum spectra.

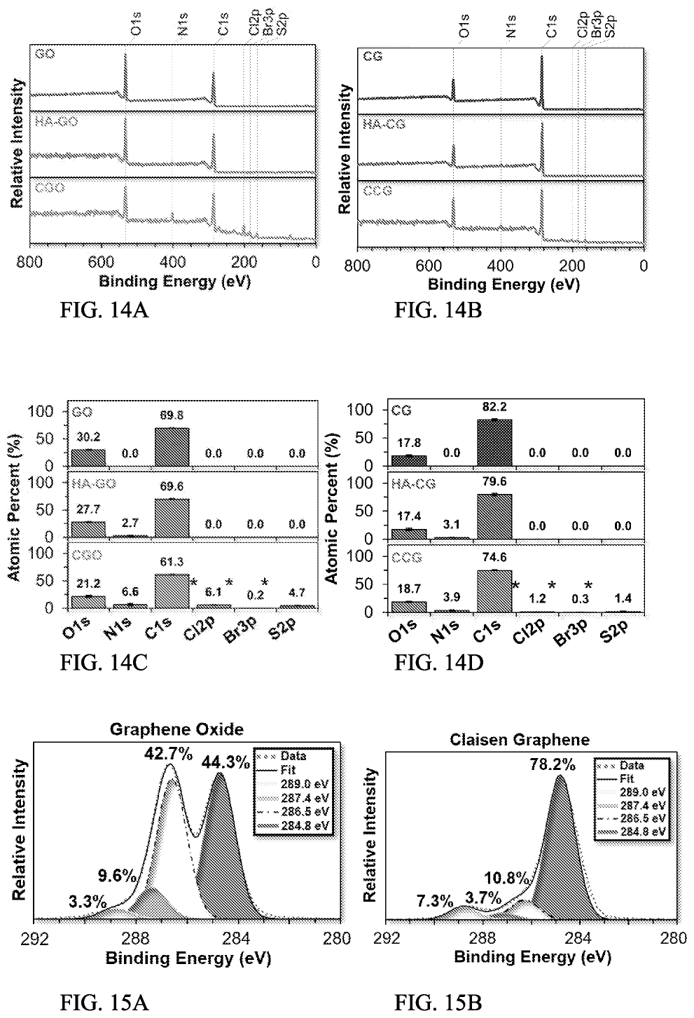

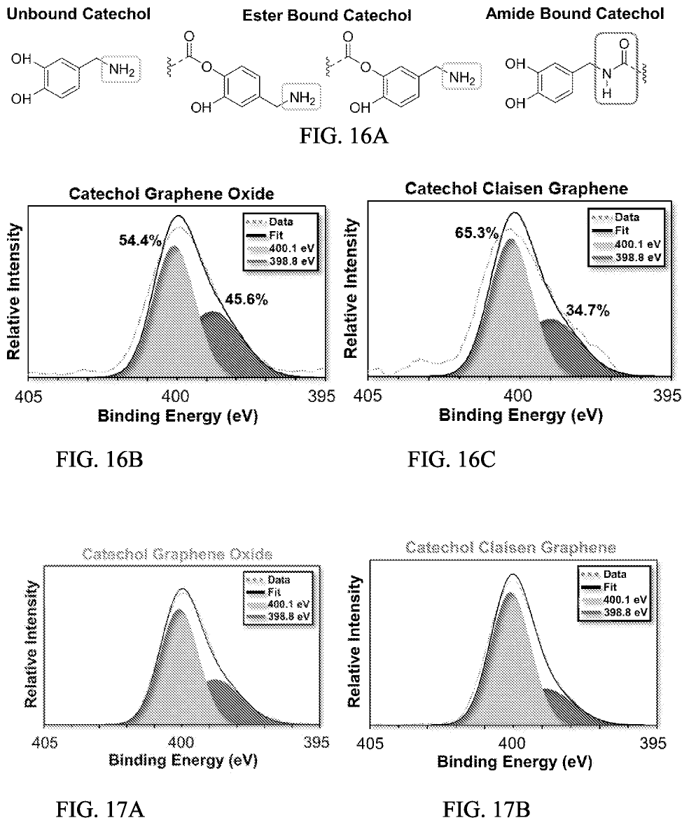

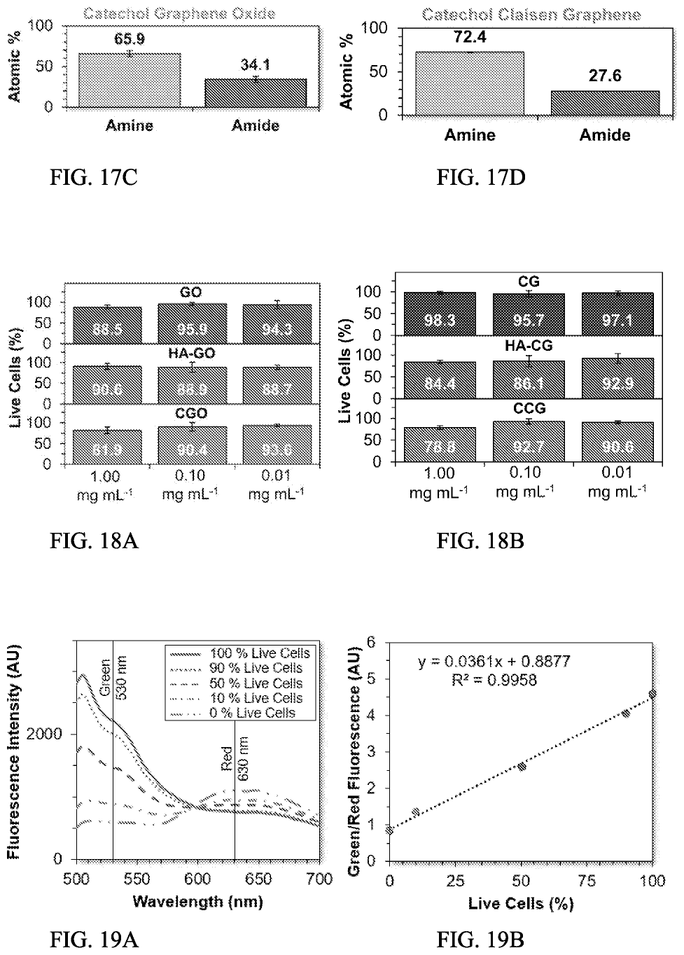

The long-term stability of chelating groups on FGMs in AMD-like conditions suggest materials could be used for extended periods of time. Here, we found chelating groups on FGMs were stable in AMD-like conditions for one week or longer. Depreciable chemical changes in FGMs were not observed by XPS. After 1 week in acidic conditions, the chelating groups on the graphenic backbones of the FGMs remained unchanged. There were negligible changes in the XPS elemental composition (FIGS. 14A-14D), carboxylic acids (FIGS. 7A and 15A-15B), or amide bound catechols (FIGS. 16A-16C) of the FGMs when compared to the unaged FGM powders (FIGS. 6A-6D, 7A-7E, 16A, and 17A-17D).

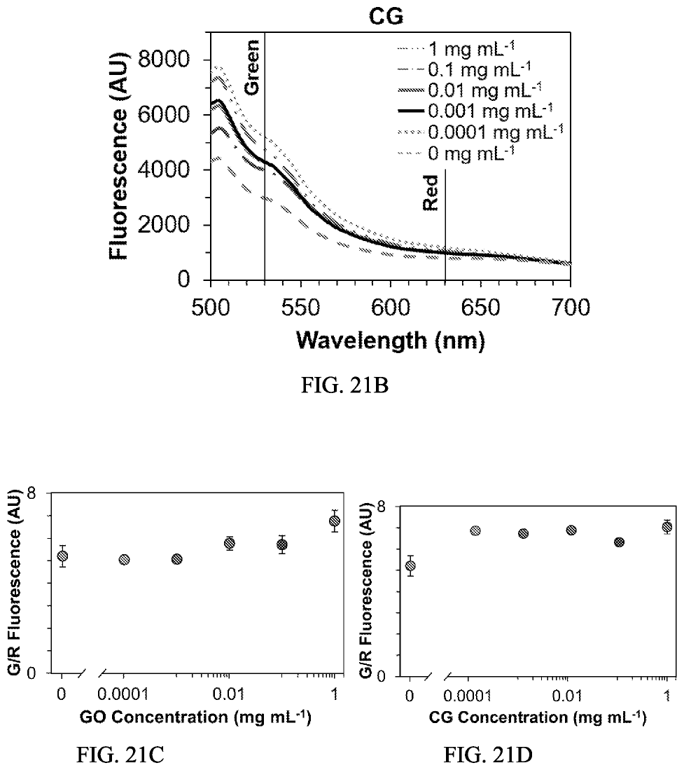

Ecological Impact of FGMs: Small concentrations of FGMs that may enter the environment are expected to have minimal ecological effects due to the compatibility of FGMs. The compatibility of FGMs with mammalian models in vitro and in vivo has been previously demonstrated (Sydlik, S. A. et al. In Vivo Compatibility of Graphene Oxide with Differing Oxidation States. ACS Nano 2015, 9(4): 3866-3874; Arnold, A. M. et al. Phosphate Graphene as an Intrinsically Osteoinductive Scaffold for Stem Cell-Driven Bone Regeneration. PNAS 2019, 116(11): 4855-4860). However, there is a still a pervasive consensus that FGMs have bactericidal effects, which could be detrimental to microflora essential to ecological food chains. Recent studies have shown that FGMs are not bactericidal, rather, FGM impurities account for the reported antimicrobial activity of these materials (Barbolina, I. et al. Purity of Graphene Oxide Determines Its Antibacterial Activity. 2D Mater. 2016, 3(2): 025025). The FGM material described herein is well tolerated by E. coli, even in unrealistically high concentrations (0.01-1.0 mg mL⁻¹) (FIGS. 18A-18B, 19A-19B, 20A-20D, 21A-21D).

The compatibility of E. coli cells was evaluated to ascertain the effect the FGM may have on microflora in the environment. The LIVE/DEAD® BacLight™ assay was used for these cell studies, where the assay utilizes two fluorescent probes to determine the percent of live E. coli cells. FGMs are notorious fluorophore quenchers and have been documented to interfere with fluorescent assays such as, the methylthiazolyldiphenyl-tetrazolium bromide (MTT) assay for mammalian cells. Thus, a control experiment was performed with the LIVE/DEAD® BacLight™ assay to ascertain if the FGMs quenched the fluorophores in the assay.

No treatment samples only containing E. coli cells were utilized for the control experiment. Then, either GO or CG was added to the cells. The total concentrations of GO and CG spanned several orders of magnitude (0.0001, 0.001, 0.01, 0.1, 1.0 mg mL⁻¹). The samples were then subjected to the LIVE/DEAD® BacLight™ assay.

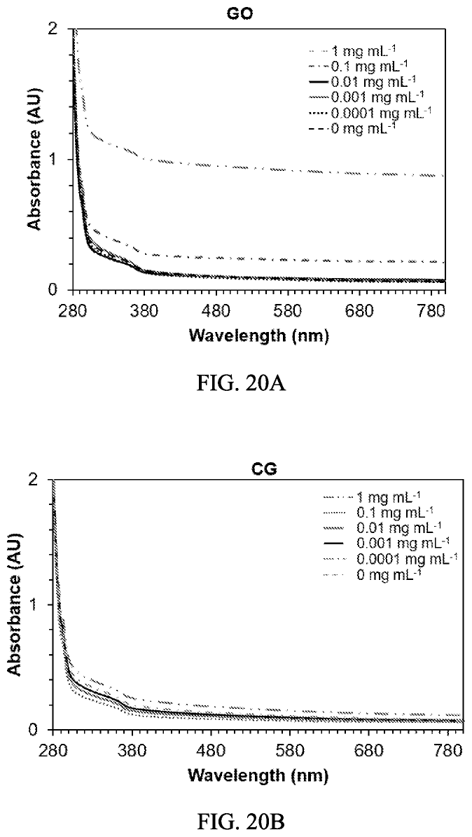

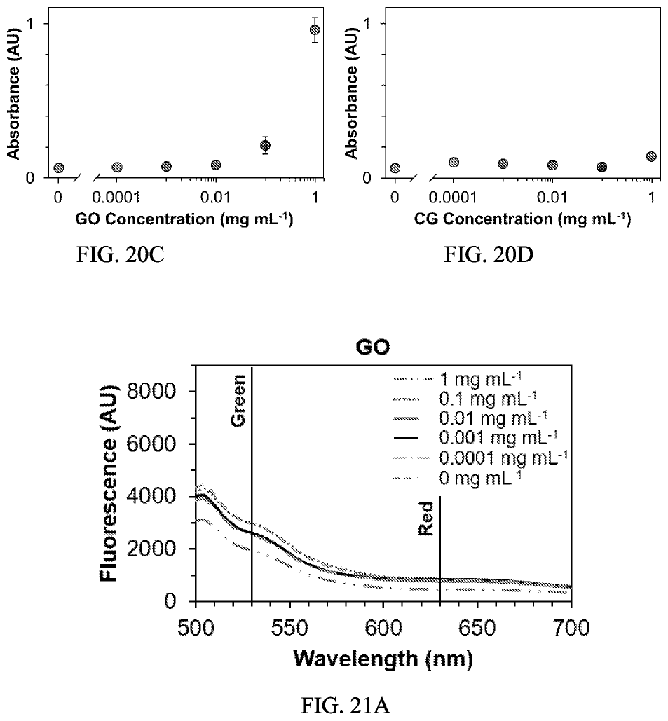

The absorbance and fluorescence emission of the samples was analyzed and it was found that the FGM materials cause minimal assay interference. For example, the GO began to interfere with the absorbance of the assay when compared to a no treatment control. CG, on the other hand did not display any deviations from the no treatment control (FIGS. 20A-20D). The green-to-red fluorescence ratio also demonstrated that GO and CG did not interfere with the assay in comparison to a no treatment control (FIG. 20A-20D). Thus, we concluded that our FGMs did not interfere with the results of the LIVE/DEAD® BacLight™ assay, especially since extreme care was taken to remove FGMs from samples prior to testing. Conclusion

Six FGMs that covalently incorporate a variety of metal-chelating groups, such as, carboxylic acids, hydroxamic acids, and catechols were synthesized. When tested for efficacy, the six FGMs demonstrated a reversible capacity to remove aluminum from acidic water, chelating up to 21 μg per mg FGM. Further, when exposed to E. coli as an approximation for environmental compatibility, viability was unaffected even at high concentrations, suggesting these FGMs to be non-toxic. Thus, these FGMs fulfill show promise as a viable means for aluminum remediation.

Having described this invention above, it will be understood to those of ordinary skill in the art, that the same can be performed within a wide and equivalent range of conditions, formulations, and other parameters without affecting the scope of the invention or any embodiment thereof.

1. A functional graphene composition, comprising:
a graphene scaffold; and
one or more metal chelating functional groups covalently bonded to the graphene scaffold,
wherein the one or more metal chelating functional groups comprise a N-alkoxyamide or hydroxamic acid moiety.

2. The compound of claim 1, wherein the graphene scaffold comprises graphene oxide.

3. The compound of claim 1, wherein the graphene scaffold comprises Claisen graphene oxide.

4. The compound of claim 1, wherein the N-alkoxyamide moiety comprises the structure: 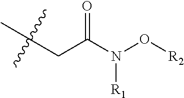
where R₁ is hydrogen or C₁₋₆ alkyl, e.g., R₁ is hydrogen; and
where R₂ is —(CH₂)ₙ—CH₃, where n ranges from 0 to 5.

5. The compound of
wherein the hydroxamic acid moiety comprises the structure: 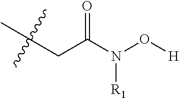
where R₁ is hydrogen or C₁₋₆ alkyl.

6. The compound of claim 1, wherein the graphene scaffold further comprises magnetic nanoparticles linked thereto.

7. (canceled)

8. A porous structure comprising:
a porous substrate; and
a functional graphene composition on the porous substrate, comprising a metal- chelating functional group covalently bonded to a graphene scaffold, wherein the metal-chelating functional group comprises a carboxyl moiety, a hydroxamic acid moiety, a N-alkoxylamide moiety, a catechol moiety, or a combination thereof.

9. The porous structure of claim 8, wherein the metal-chelating functional group comprises:
a N-alkoxyamide moiety having the structure: 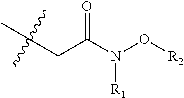
where R₁ is hydrogen or C₁₋₆ alkyl, e.g., R₁ is hydrogen; and
where R₂ is —(CH₂)ₙ—CH₃, where n is from 0 to 5; or
a hydroxamic acid moeity having the structure: 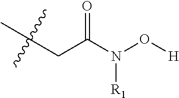
where R₁ is hydrogen or C₁₋₆alkyl.

10. (canceled)

11. The porous structure of claim 8, wherein the metal-chelating functional group comprises a 1,2-dihydroxybenzene moiety.

12. The porous structure of claim 11, wherein the metal-chelating functional group comprises an N-[2-(3,4-dihydroxyphenyl)ethyl]amide moiety.

13. The porous structure of claim 8, wherein the porous substrate comprises a clay, a rock, a polysaccharide, a polymer, a ceramic, a graphene, or a combination of any of the preceding.

14. The porous structure of claim 13, wherein the porous substrate is a three-dimensional graphene matrix.

15. The porous structure of claim 14, wherein the three-dimensional graphene matrix is formed from the functional graphene composition.

16. The porous structure of claim 13, wherein the porous substrate comprises a porous sheet.

17. (canceled)

18. The porous structure of claim 8, wherein the functional graphene composition is covalently bonded to the porous substrate.

19. (canceled)

20. A method of removing dissolved metal from an aqueous liquid, the method comprising: adding to the aqueous liquid a compound comprising a functionalized graphene comprising a metal-chelating functional group covalently bonded to a graphene, wherein the metal-chelating functional group comprises a carboxyl moiety, a hydroxamic acid moiety, a N- alkoxylamide moiety, a catechol moiety, or a combination thereof, thereby, chelating the dissolved metal.

21. The method of claim 20, wherein the metal-chelating functional group comprises:
a N-alkoxyamide moiety comprising the structure: 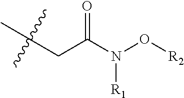
where R₁ is hydrogen or C₁₋₆ alkyl, e.g., R₁ is hydrogen; and
where R₂ is —(CH₂)ₙ—CH₃, where n is from 0 to 5; or
a hydroxamic acid moiety having the structure: 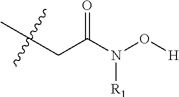
where R₁ is hydrogen or C₁₋₆ alkyl, e.g., R₁ is hydrogen.

22-24. (canceled)

25. The method of claim 20, wherein the functionalized graphene is on a porous substrate, or forms a porous structure.

26-30. (canceled)

31. The method of claim 20, wherein the aqueous liquid is drinking water, wastewater, or acid mine drainage and/or the dissolved metal comprises aluminium (Al), lead (Pb), mercury (Hg), iron (Fe), manganese (Mn), cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), Tbulium (Tm), ytterbium (Yb), and yttrium (Y), or any combination thereof.

32-35. (canceled)

36. The method of claim 20, further comprising after adding the compound to the aqueous liquid to chelate the dissolved metal, optionally, washing the composition comprising the chelated metal under conditions in which the metal is retained on the composition, and eluting the chelated metal from the composition.
